(19) United States
(12) Patent Application Publication
(10) Pub. No.: US 2017/0374608 A1
(43) Pub. Date: Dec. 28, 2017

(54) METHOD AND SYSTEM FOR NETWORK ACCESS DISCOVERY

(71) Applicants: Xu LI, Nepean (CA); Hang ZHANG, Nepean (CA); William Anthony GAGE, Stittsville (CA)

(72) Inventors: Xu LI, Nepean (CA); Hang ZHANG, Nepean (CA); William Anthony GAGE, Stittsville (CA)

(73) Assignee: HUAWEI TECHNOLOGIES CO., LTD., SHENZHEN (CN)

(21) Appl. No.: 15/631,656

(22) Filed: Jun. 23, 2017

Related U.S. Application Data
(60) Provisional application No. 62/355,734, filed on Jun. 28, 2016.
(60) Provisional application No. 62/377,045, filed on Aug. 19, 2016.

(51) Int. Cl. H04W 48/16; H04W 48/08; H04W 48/20; H04W 60/00

(52) U.S. Cl. CPC H04W 48/16; H04W 60/00; H04W 48/08; H04W 48/20

(57) ABSTRACT

Methods and systems are disclosed which can reduce energy and overhead information by reducing the need for a UE to decode every (System Information Block) SIB from overhead signaling for every cell for every cell reselection. Instead the UE can determine information from Physical Cell ID (PCI) information received by the map download and update procedures described herein. A map contains a list of cells including cell-specific system information including location; it may also be associated with a geographic boundary. In the map, each 3GPP cell is indexed by PCI (physical cell id). In some embodiments the UE retrieves dynamic information from the Master Information Block (MIB) to determine what SIB information needs to be decoded. Furthermore, in some embodiments, this can be applied for both 3GPP cells and non-3GPP cells.

### CROSS-REFERENCE TO RELATED APPLICATIONS

This disclosure claims priority to U.S. Provisional Patent application Ser. No. 62/355,734 titled “Method and System for Network Access Discovery” and filed Jun. 28, 2016, and U.S. Provisional Patent Application Ser. No. 62/377,045 titled “Method and System for Network Access Discovery” and filed Aug. 19, 2016, the disclosures of which are hereby incorporated by reference in their entirety.

### TECHNICAL FIELD

This disclosure relates to the field of wireless communication networks in general, and to the field of network access discovery in particular.

### BACKGROUND

When a multi-mode user equipment (UE) attempts to connects to a radio access network (RAN) of a public land mobile network (PLMN), the UE undergoes a network access discovery procedure, which includes a cell selection procedure. The PLMN can include networks defined by the 3rd Generation Partnership Project (3GPP) such as GMS, UMTS, LTE, etc. The cell selection procedure includes searching for cells, selecting a cell to provide service, and tuning to the control channel of the cell in a process known as “camping on the cell”, and then registers with the cell.

In order to ensure the service does not degrade, the UE keeps measuring reference signal measurements (reference signal received power/quality (RSRP/RSRQ)) for the cell, even when the UE is in idle mode. If these measurements are poor, the UE reselects a cell (selects an alternative cell to camp on). Otherwise, the UE remains registered to the current cell, but continues to evaluate cell reselection criteria and performs cell reselection as needed. Cell reselection may include PLMN reselection.

In the cell search step, the UE listens to cell synchronization signals and obtains Physical Cell Identity (PCI); it is then able to locate reference signal, measure RSRP/RSRQ, and decode system information such as master information block (MIB) and system information block (SIB) parameters. MIB parameters include downlink cell bandwidth, SFN, etc., and SIB parameters include SIB1 (e.g. PLMN ID, cell ID, etc.) and SIB2 (e.g. RACH parameters, cell barring information, etc). The MIB and SIB parameters are cell specific and transmitted periodically by each cell. The system information and RSRP/RSRQ are used for performing subsequent steps in the cell (re)selection process.

This cell (re)selection procedure is not efficient; it is time-consuming and energy-consuming, and produces a lot of overhead signaling which uses spectrum and consumes resources of devices (for example, it puts a load on a UE battery). Furthermore, this inefficiency can especially problematic in scenarios which utilize dense small cell environments, in which small cell signals can be interfered by strong macro cell signal, and in scenarios where multiple Radio Access Technologies (RATs) and multiple carrier bands co-exist.

There is a need for a system that overcomes these weaknesses and enables integration of various 3GPP access and non-3GPP access RATs.

### SUMMARY

Those skilled in the art will appreciate that terms such as “cell”, “cell signal”, and other language related to cellular networks is used for the purpose of simplicity an assuring understanding in view of existing standards. The discussions below should be understood to apply to non-cellular networks as well as networks that are cellular in nature. Where reference is made to a “cell” it should be understood to be the equivalent of a serving area of a network access point, and reference to “cell signals” should be understood to be the equivalent of wireless signals transmitted by a mobile network.

Methods and systems are disclosed which can reduce energy and overhead information by reducing the need for a UE to decode every (System Information Block) SIB from overhead signaling for every cell for every cell reselection. Instead the UE can determine information from Physical Cell ID (PCI) information received by the map download and update procedures described herein. A map contains a list of cells including cell-specific system information including location; it may also be associated with a geographic boundary. In the map, each 3GPP cell is indexed by PCI (physical cell id). In some embodiments the UE retrieves dynamic information from the Master Information Block (MIB) to determine what SIB information needs to be decoded. Furthermore, in some embodiments, this can be applied for both 3GPP cells and non-3GPP cells.

An aspect of the disclosure provides a method for network access discovery comprising: receiving a map containing cell information for potential serving cells; selecting cells based on the received map; and utilizing the map to determine if further information needs to be decoded during any cell reselection and only decodes further information as needed.

Another aspect of the disclosure provides a network access discovery and selection function configured to download and update neighborhood maps for UEs.

Another aspect of the disclosure provides a UE configured to receive neighborhood maps providing information as to potential serving cells, obtaining static and/or semistatic information from the map and utilizing the map to determine if further information needs to be decoded during any cell reselection and only decodes further information as needed.

Another aspect of the disclosure provides a method of cell selection performed by a user equipment (UE). Such a method includes obtaining physical cell identifier (PCI) information associated with an access node in accordance with a signal received from the access node. Such a method also includes transmitting a registration request to the access node using system information associated with the access node, the system information selected from a stored map in accordance with location information associated with the UE and the obtained PCI. It is noted that a registration request is sometimes referred to as an access request. In some embodiments, the method further includes receiving a master information block from the access node. In some embodiments, the location information includes area identification information from a master information block received from the access node. In some embodiments, the area identification information defines a region including access nodes, with each access node within the region having a unique physical cell identifier (PCI). It is noted that due to a limited number of PCIs, access nodes in large networks do not always have unique PCIs. In some embodiments, the method further includes locally determining the location information. In some embodiments, the method further includes requesting a map update responsive to a triggering criteria. In some such embodiments, the triggering criteria includes receiving a better quality signal from an access node not identified in the stored map. In some embodiments the triggering criteria includes moving towards the boundary of the map area (of the region) or the tracking area of the UE. In some embodiments, the stored map further includes policy information. In some such embodiments the method further includes determining criteria is satisfied according to the policy information included in the map; and selecting an access node responsive to the determining. This can allow for conditional decisions made by the UE. In some embodiments, the stored map further includes system information and a system information version number for each access node and the master information block for each access node includes a system version number. In some such embodiments, the method further includes retrieving a system information version number from the map and comparing the retrieved system information version number with the system version number contained in the received master information block. In some such embodiments the UE uses the system information from the map for each access node in which the map system information version number matches the master information block system information version number. For example, this can allow the UE to use the system information from the stored map rather than decoding the system information blocks from access nodes to which the UE may subsequently select in a cell reselection procedure. In some embodiments, the method further includes, for each access node in which the retrieved system information version number does not match the system version number contained in the received master information block for that access node, decoding system information block information received from that access node. In some embodiments, obtaining PCI information includes determining the PCI in accordance with synchronization signals (e.g., the primary synchronization signal (PSS) and the secondary synchronization signal (SSS)) transmitted by the access node.

Another aspect of the disclosure is a method performed by an access node. Such a method includes transmitting a master information block including area identification (area ID) information defining a region comprising access nodes, each access node within the region having a unique physical cell identifier (PCI). In some embodiments, the master information block includes a system version number for each access node within the topological region. In some embodiments, the method further includes receiving a map update from a network discovery function; and transmitting the map update to a user equipment (UE). In some embodiments, the method further includes receiving a map update from a network discovery function; paging a user equipment (UE) to become active; and transmitting the map update to the UE.

Another aspect of the disclosure provides a method of generating a network discovery map, performed by a network access discovery and selection function (NADSF). The NADSF can be a core network function. Such a method includes generating a map associating a physical cell identifier and location information with system information associated with access nodes in a radio access network, for a UE, in accordance with a location associated with the UE; and transmitting the map for forwarding to the UE. In some embodiments, the step of generating a map is performed in response to receipt of an indication of receipt of a registration request associated with the UE. In some embodiments, the step of generating a map includes generating an update to a map previously provided to the UE, and wherein the step of generating is performed in response to receiving an indication of a map update event. In some such embodiments, the map update event can be an event associated with the mobility of the UE. In some embodiments, the method further includes computing policy information for at least one of the UE and the area. In such embodiments, generating the map is performed in accordance with the computed policy information.

Another aspect of the disclosure provides a method performed by a mobility management function. Such a method includes transmitting to an NADSF, a notification associated with UE mobility. In some embodiments, transmitting the notification is performed in response to detection of a change of UE location. In some embodiments, transmitting the notification is performed in response to detection of a change in the mobility state of the UE. In some embodiments, the mobility state of the UE is selected from the group comprising: high mobility; normal mobility; and low or no mobility. In some embodiments, the method further includes receiving a subscription request from the NADSF. In some such embodiments, the subscription request is associated with the UE.

Other aspects of the disclosure provide for network elements or electronic devices configured to perform the methods described herein. For example, network elements can be configured as an access node or a network access discovery and selection function (NADSF) which performs network access discovery and selection (NADS). For example network elements, or user equipment, can include a processor, and machine readable memory storing machine readable instructions which when executed the processor, cause the network element, or user equipment, to perform the methods described herein.

For example, an aspect provides a user equipment (UE) including a processor; and machine readable memory storing executable instructions which when executed by the processor cause UE to obtain physical cell identifier (PCI) information associated with an access node in accordance with a signal received from the access node; and transmit a registration request to the access node using system information associated with the access node, the system information selected from a stored map in accordance with location information associated with the UE and the obtained PCI. In some embodiments the executable instructions further cause the UE to receive a master information block from the access node; wherein the location information comprises area identification information from the master information block.

As another example, another aspect provides an access node (AN) including a processor; and machine readable memory storing executable instructions which when executed by the processor cause the AN to transmit a master information block including area identification (area ID) information defining a region comprising access nodes, each access node within the region having a unique physical cell identifier (PCI). In some embodiments the master information block includes a system version number for each access node within the topological region.

As another example, another aspect provides a network access discovery and selection function (NADSF) implemented in a network element including a processor; and machine readable memory storing executable instructions which when executed by the processor cause the NADSF to generate a map for a UE, in accordance with a location associated with the UE; and transmit the map for forwarding to the UE.

As another example, another aspect provides a mobility management function implemented in a network element including a processor; and machine readable memory storing executable instructions which when executed by the processor cause the mobility management function to transmit to an NADSF, a notification associated with UE mobility.

The foregoing and other objects, features, aspects and advantages of the present invention will become more apparent from the following detailed description, taken in conjunction with the accompanying drawings which description is by way of example only.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 illustrates a network architecture according to an embodiment.

FIG. 2 illustrates a signal flow describing the UE-initiated neighborhood map acquisition/update procedure (pull mode), according to an embodiment.

FIG. 3 illustrates a signal flow describing the network-triggered neighborhood map update procedure (pull or push), according to an embodiment.

FIG. 4 illustrates a signal flow describing an alternate network-initiated neighborhood map update procedure (for push mode), according to an embodiment.

FIG. 5 illustrates an embodiment for the architecture using Location-Assisted Network Discovery and Selection (LAND)

FIG. 6 illustrates an alternate embodiment for an architecture using LAND.

FIG. 7 illustrates a logical signal flow where the UE requests a neighborhood map from the MM according to an embodiment.

FIG. 8 illustrates an embodiment where UE1 requests a map from UE2.

FIG. 9 illustrates a process of waking an idle UE to determine if it should connect with the network according to an embodiment.

FIG. 10 illustrates an alternate method from the method used by the UE in FIG. 9 to determine if it should enter connected mode or inform the network of its updated location.

FIG. 11 illustrates a signal flow where the MM has the option to use operator policy to update the neighborhood map when it accepts a UE's location update, according to an embodiment.

FIG. 12 illustrates a signal flow where the SM requests that the MM determine the location of the UE and the UE optionally reselects the cell and optionally triggers a UE handover, according to an embodiment.

FIG. 13 illustrates a signal flow with alternate UE actions (from FIG. 10) in response to the SM's UE location request, according to an embodiment.

FIG. 14 illustrates a variation of the network architecture illustrated in FIG. 1, according to an embodiment.

FIG. 15 illustrates an NDS procedure executed by a (processor of the) UE, according to an embodiment.

FIG. 16 illustrates a signal flow describing the UE-initiated neighborhood map acquisition/update procedure (pull mode), according to an embodiment

FIG. 17 illustrates a signal flow describing an example of an NDSF initiated neighborhood map update procedure according to another embodiment.

FIG. 18 illustrates an embodiment that shows interfaces used by the UE, AN, and MM used to communicate with the PCF (and NADSF).

FIG. 19 illustrates a signal flow describing an example update notification to the UE via push mode, according to an embodiment.

FIG. 20 is an exemplary block diagram of a processing system that may be used for implementing the various network functions, according to an embodiment.

### DESCRIPTION OF EMBODIMENTS

In conventional evolved packet system (EPS) networks, network discovery is based on blind search and measurement at the physical layer. Such a procedure can be resource consuming (e.g., time-consuming and energy-consuming, using processing and battery resources) for both UEs and the network. Such a process is not only inefficient but can be ineffective in some scenarios, such as dense small cell environments in which small cell reference signals are interfered by strong macro cell reference signals, and scenarios where multiple RATs and multiple carrier bands co-exist.

Accordingly, embodiments of a next generation system are discussed which includes a network discovery mechanism that overcomes these weaknesses and also enables integration of various 3GPP RATs and non-3GPP RATs.

Embodiments perform network discovery by leveraging location information. Embodiments provide a Location Assisted Network Discovery solution which utilizes a neighborhood map which defines the tracking area of the UE with respect to at least one of the following: the UE capabilities, UE mobility, UE location, the network(s), and in some embodiments, also with respect to operator policy. Such a solution can support network discovery and selection requirements (for example as set out in “Key Issue 17: 3GPP architecture impacts to support network discovery and selection” from 3GPP TR 23.799: “Study on Architecture for Next Generation System”). In some embodiments the map area (also referred to as a service area) defined by the neighborhood map can be larger than the tracking area.

Such a neighborhood map is a data structure, for example a lookup table which provides information about potential access points (APs) with serving area's within a geographic area. In some embodiments such a map can include a potential serving radio node ID list and further can include for each node ID, information such as frequency band, interface, code, load, etc. This map is updated when the UE changes its mobility pattern or is about to leave the tracking area of the UE. As should be appreciated, the mobility pattern can change if the UE switches from a high mobility state (e.g. on a fast moving vehicle) to a low mobility state (slow moving vehicle or user exits vehicle to walk) to a no-mobility state (stationary) or if UE's expected moving trajectory changes (e.g. due to change in moving direction). When such a change occurs, the map can be updated to reflect macro or micro cells as appropriate and/or to update the cell list in the map. Further, in embodiments for which the map area is not the same as the tracking area, the map can be updated if the UE is about to leave the map area. In some embodiments, for example, for which the map area is the same as the tracking area, the map update process can be integrated with the location update process. As the UE moves, it checks its location, and can reselect cell(s) with respect to its location and the neighborhood map. The UE listens to paging messages and performs location update according to the cell information specified in the map, without needing to perform measurement-based cell reselection.

3GPP TS 23.402: “Architecture enhancements for non-3GPP accesses,” March 2016 describes an access network discovery and selection function (ANDSF). Such an ANDSF assists a UE in the discovery of operator preferred non-3GPP access networks by providing the UE with these networks' information and the rules policing the connection to these networks. This disclosure proposes to extend the functionality of ANDSF to additionally assist UE in cell (re)selection for both non-3GPP access and 3GPP access. Indeed, the procedure of network discovery and selection and the procedure of cell (re)selection are intertwined, as there is an access network behind every access point (cell). To differentiate it from the version in EPC, the extended version described herein is referred to as a network access discovery and selection function (NADSF) which performs network access discovery and selection (NADS). Alternatively the terms network discovery and selection function (NDSF) which performs network discovery and selection (NDS) are used.

The assistance offered by the NADSF includes using the neighborhood map. As discussed above, the neighborhood map contains a list of cells. In some embodiments such a map includes cells for 3GPP and/or non-3GPP), and the map can include static and/or semi-static system information related to NADS. The map may also be associated with a geographic boundary. The 3GPP cells in the map are indexed by PCI, and the associated system information may include all of the information normally broadcast in System Information Blocks (SIBs), for example. Non-3GPP cell system information may be the information specified in 3GPP TS 23.402: “Architecture enhancements for non-3GPP accesses (Release 15)”, June 2017.

According to some embodiments, the neighborhood map can be generated by the NADSF according to operator policy, UE capabilities, UE mobility and UE location. When UE moves out the map area or is about to move out the map area, it needs to perform a neighborhood map update. The map update may take place in a pull-based mode or in a push-based mode. In the pull-based mode, the UE transmits a request to the NADSF for a map update. In the push-mode, the NADSF informs the UE to update neighborhood map.

In some embodiments in which the UE knows its geographic location, for example by GPS, a pull-based map update may occur when the UE gets close enough to the geographic boundary. If the UE does not know its geographic location or if the geographic boundary of the map is not provided, a pull-based map update may occur when the UE finds that the best-quality cell is not in the map. In some embodiments, a push-based map update can be used. For example, a mobility management (MM) function may be able to detect whether a UE is going to move out the map area and trigger the pushing of a map update from the NADSF to the UE. In some embodiments a Map update, whether pull-based or push-based, may also be triggered when a map update timer has expired or when the UE mobility pattern changes.

In some embodiments during the cell search step of cell (re)selection, the UE listens to cell synchronization signals (i.e., the primary synchronization signal (PSS) and secondary synchronization signal (SSS)) and obtains PCIs. The UE then locates reference signals, measures RSRP/RSRQ, and decodes MIB (e.g. downlink cell bandwidth, SFN, etc.). The UE can then extract the cell's system information from the neighborhood map, as opposed to needing to decode all of the system information over the air. In some embodiments the MIB may be used by the UE to determine whether the UE needs to decode any SIBs on the fly to obtain dynamic system information (for example cell barring information) for NADS. Accordingly in some embodiments the system adds information to the MIB to advise whether the UE needs to decode SIBs (for example based on age of SIB information in the map and for cell barring). The age can be reflected by a version number, a time stamp, or other indicator. In some embodiments, it may be the hash value of the system information. The UE decodes those SIBs only when necessary. Afterwards, the UE proceeds with the subsequent steps for cell (re)selection. As should be appreciated, the steps of cell (re)selection can include obtaining physical cell identifier (PCI) information associated with an access node in accordance with a signal received from the access node; and transmitting a registration request to the access node using system information associated with the access node, the system information selected from a stored map in accordance with location information associated with the UE and the obtained PCI It is noted that a registration request is sometimes referred to as an access request. For example, this can allow the UE to use the system information from the stored map rather than decoding the system information blocks from access nodes to which the UE may subsequently select in a cell reselection procedure.

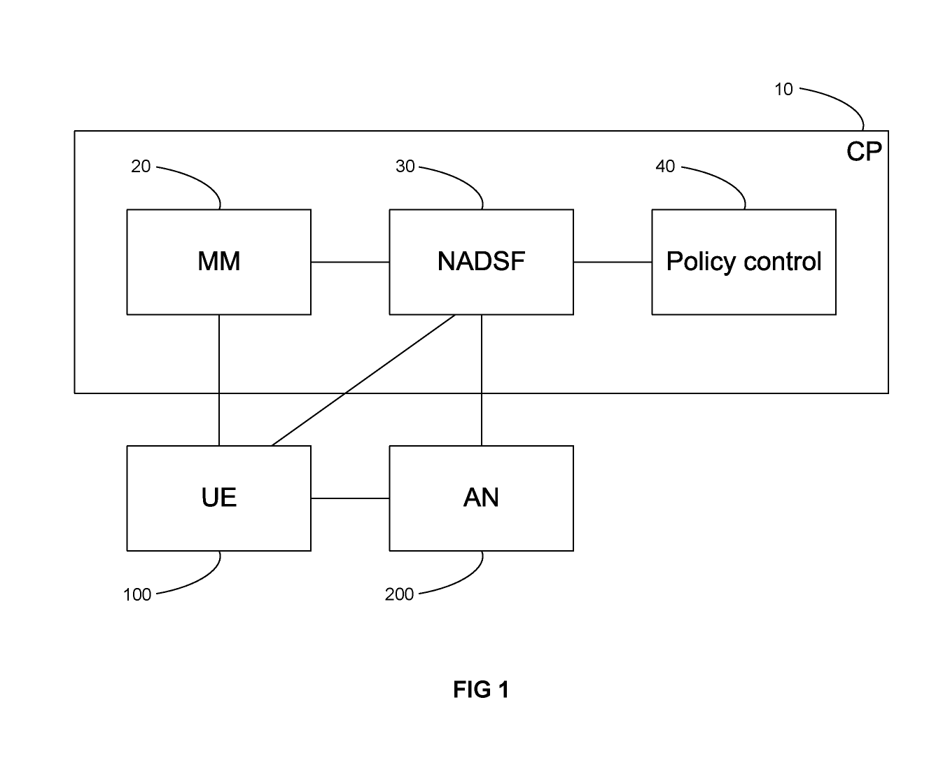

FIG. 1 illustrates a network architecture according to an embodiment, where MM stands for a mobility management function, CP stands for control plane and AN stands for access node. It should also be noted that an MM can also be called an access and mobility management function (AMF). FIG. 1 illustrates the Core Network (CN) control plane functions (CP 10) of the MM 20, NADSF 30, and Policy Control 40 which communicate with the UE 100 and AN 200. The AN 200 is part of a Radio Access Network (RAN). It should be noted that the connection between the UE 100 and NADSF 30 is a logical connection. This logical connection is shown in FIG. 1 to illustrate that the NADSF 30 considers the UE's location when selecting ANs to be included in the neighborhood map. In other words, the NADSF 30 generates maps which are UE specific, or specific to a group of UEs. It should also be noted that in some embodiments the NADSF and Policy control functions can be combined into a single function called a Policy Control Function (PCF). Further it is pointed out that UE in this specification includes phones, computers and other electronic devices associated with a user, but also can include other electronic devices not necessarily associated with a user. In this specification a UE is an electronic device that connects over a wireless communication channel to a wireless network. Accordingly a UE does not necessarily need to be associated with a user, nor does it necessarily require a user interface. For example vehicle-to-vehicle (v2v) and vehicle-to-anything (v2x) devices as well as machine to machine (m2m) or machine type communication (MTC) devices can also be considered as UEs.

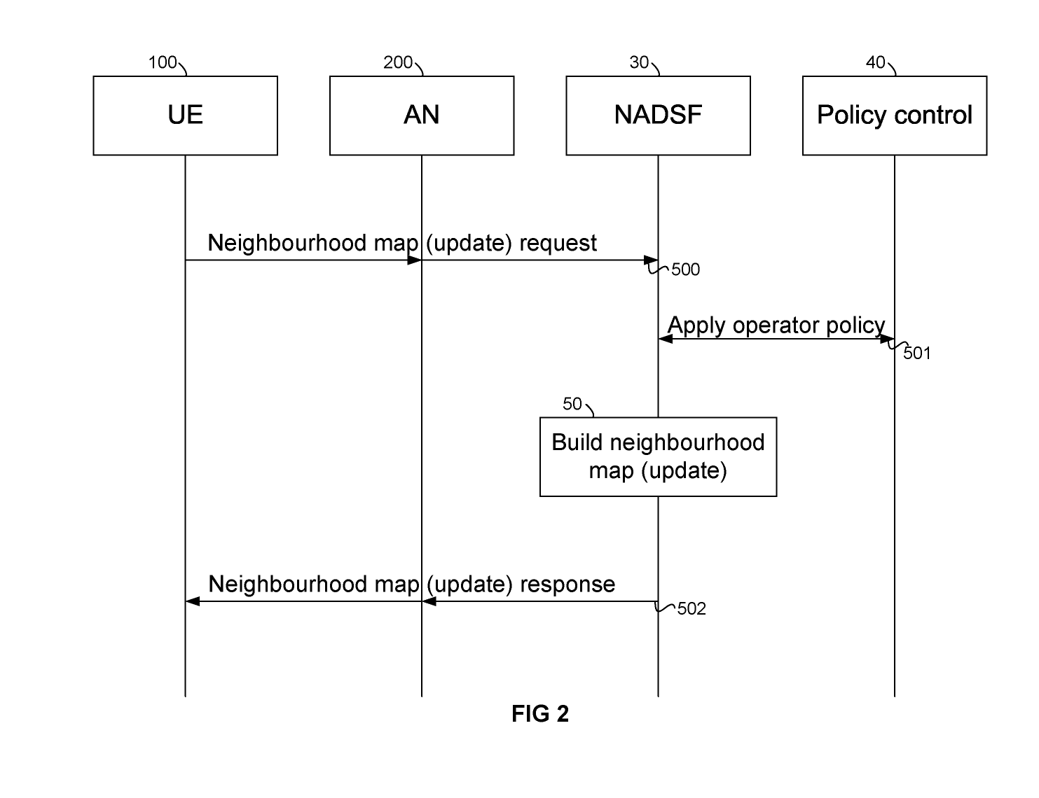

FIG. 2 illustrates a signal flow describing the UE-initiated neighborhood map acquisition/update procedure (pull mode), according to an embodiment. Such a procedure can provide an initial neighborhood map, as well as provide updates to the map. At step 1, the UE 100 sends a neighborhood map request message 500 to the NADSF 30 via the AN 200. The message may contain UE capabilities, UE mobility, UE location information, etc. At step 2, the NADSF 30 can optionally apply operator policy 501 (using information from Policy Control 40), which may restrict the UE's visibility of its neighborhood (e.g., based on security/privacy issues, reliability issues, loading issues, etc.). At step 3, The NADSF 30 establishes neighborhood map (update) of the UE according to the UE request and operator policy (this is labeled as the build neighborhood map (update) operation 50 in FIG. 2). At step 4, the NADSF 30 sends a neighborhood map (update) response 502 to the UE 100, including the neighborhood map (update) via AN 200. In some embodiments, the UE requests a map update responsive to a triggering criteria. In some such embodiments, the triggering criteria includes receiving a better quality signal from an access node not identified in the stored map. In some embodiments the triggering criteria includes moving towards the boundary of the map area (of the region) or the tracking area of the UE

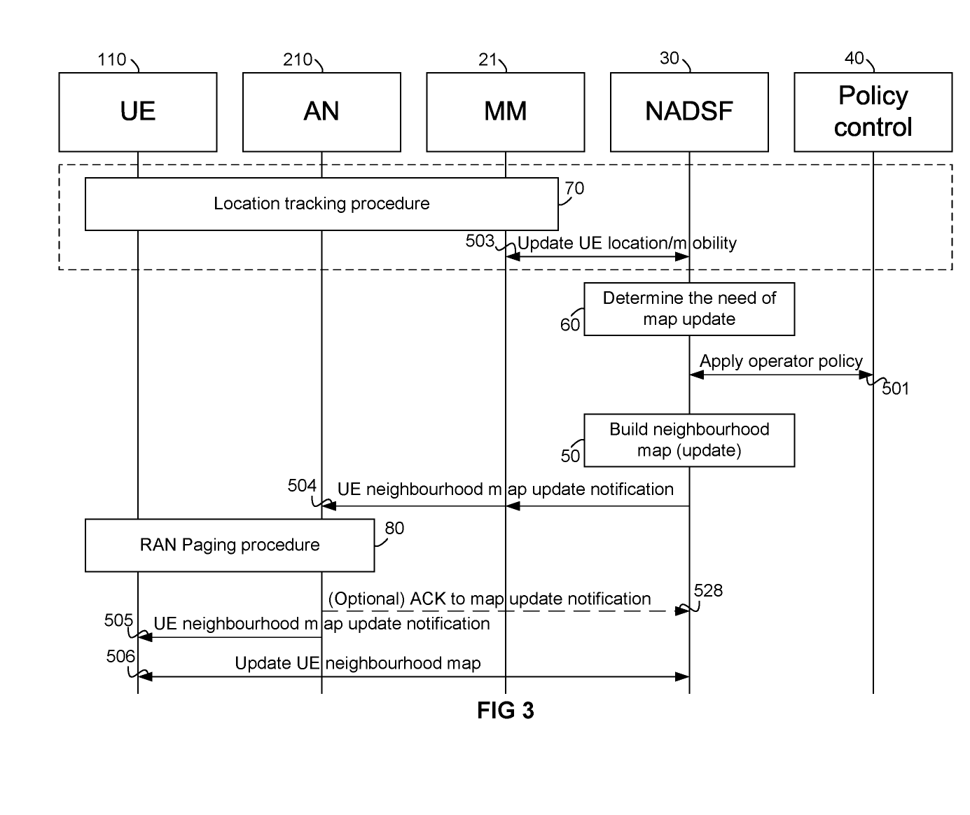

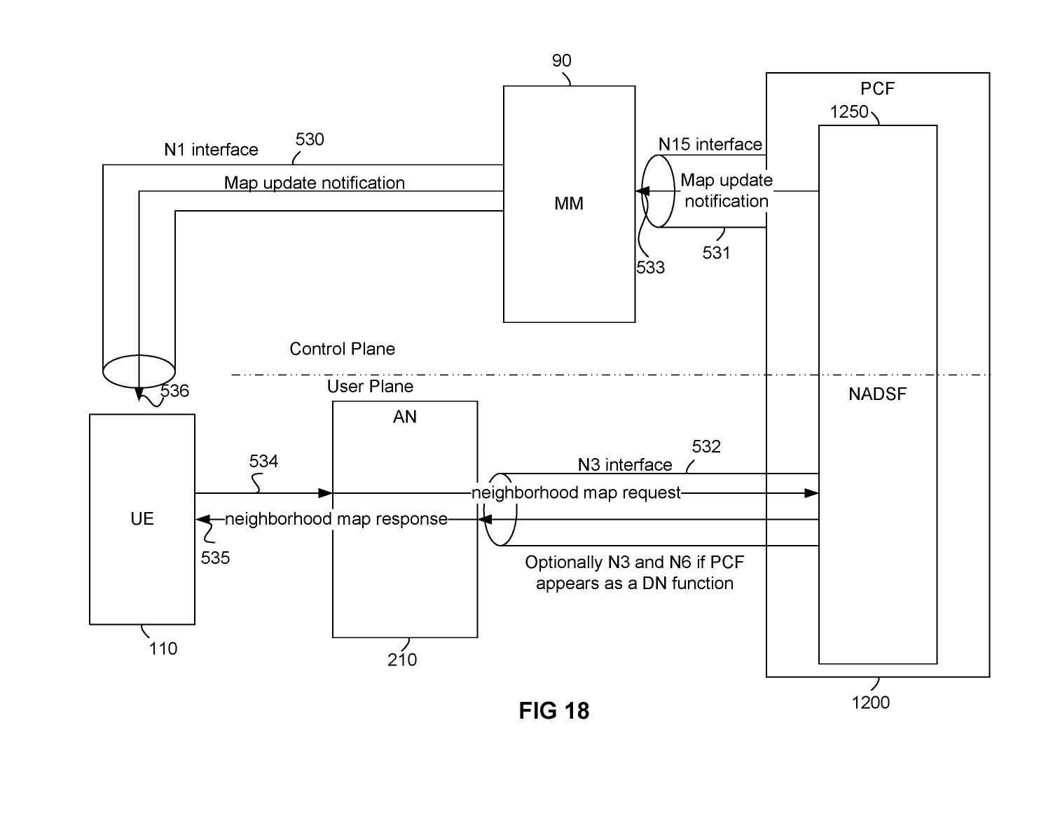

FIG. 3 illustrates a signal flow describing a network-triggered neighborhood map update procedure (pull or push), according to an embodiment. A location tracking procedure (labeled location tracking procedure 70 in FIG. 3) is engaged amongst the UE 110, the AN 210 and the MM 21 function and that the MM function updates UE location and mobility to the NADSF 30 periodically or when necessary. At step 1, the NADSF 30 receives a trigger (via the update UE location/mobility message 503) from the MM 21 function indicating that UE 110 has moved to a new location or showed a new mobility pattern. Based on this report, the NADSF 30 determines the need to perform a UE neighborhood map update (via the determine the need for map update procedure 60). At step 2, the NADSF 30 can optionally obtain and apply operator policy (from the Policy Control 40 function via the apply operator policy message 501), which may restrict the UE's visibility of its neighborhood. At step 3, the NADSF 30 updates neighborhood map of the UE 110, which may be done in accordance with the UE location, UE mobility and operator policy via a build neighborhood map (update) procedure 50. At step 4, the NADSF 30 sends a neighborhood map update notification message 504 to the UE via AN 210 and MM 21. The message may include the neighborhood map update (for push mode) or may only indicate that the UE should update its map (for pull mode). However, in some push mode embodiments a message indicating the UE should update its map can also be used. At step 5, when the AN 210 receives the downlink packet containing the neighborhood map update notification, the AN 210 wakes up the UE 110 through a RAN paging procedure 80, if the UE is in RAN idle mode. At step 6, when the UE 110 responds to the page, the AN 210 delivers the neighborhood map update notification message 505 to the UE 110 and optionally an acknowledgement message to the NADSF 30 via acknowledgement message 528. At step 7, the UE 110, initiates a transfer of the updated map from the NADSF 30 (for pull mode), and can provide an acknowledgement to the NADSF if necessary via the update UE neighborhood map message 506. It should be appreciated that step 7 is optional if the notification 504 contains the map data. It should be appreciated that the map can be transferred from the NADSF 30 to the UE 110 via control plane signaling (via the MM 21 and the AN 210) or alternatively via user plane traffic (via the AN 210). More details of the control plane and user plane approaches will be discussed below with reference to FIG. 18.

In some embodiments a type of mobility event subscription can be implemented. In such embodiments, the NADSF or the PCF provides the MM function with the map area of the UE. According to the subscription, the MM notifies the NADSF (or the PCF) when certain criteria are met, such as when the UE is moving, or about to move, out of the map area or when the UE is changing its mobility pattern. The certain criteria may be specified and provided to the MM by the NADSF or the PCF when subscribing to receive the mobility event notification. In some embodiment, the mobility event notification includes UE's location, which may be in the form of geographic coordinates, cell ID, or zone/area/region ID. In some embodiments, the mobility event notification includes the mobility pattern information of the UE, e.g. speed category, speed, moving direction, expected location in a future time window, etc.

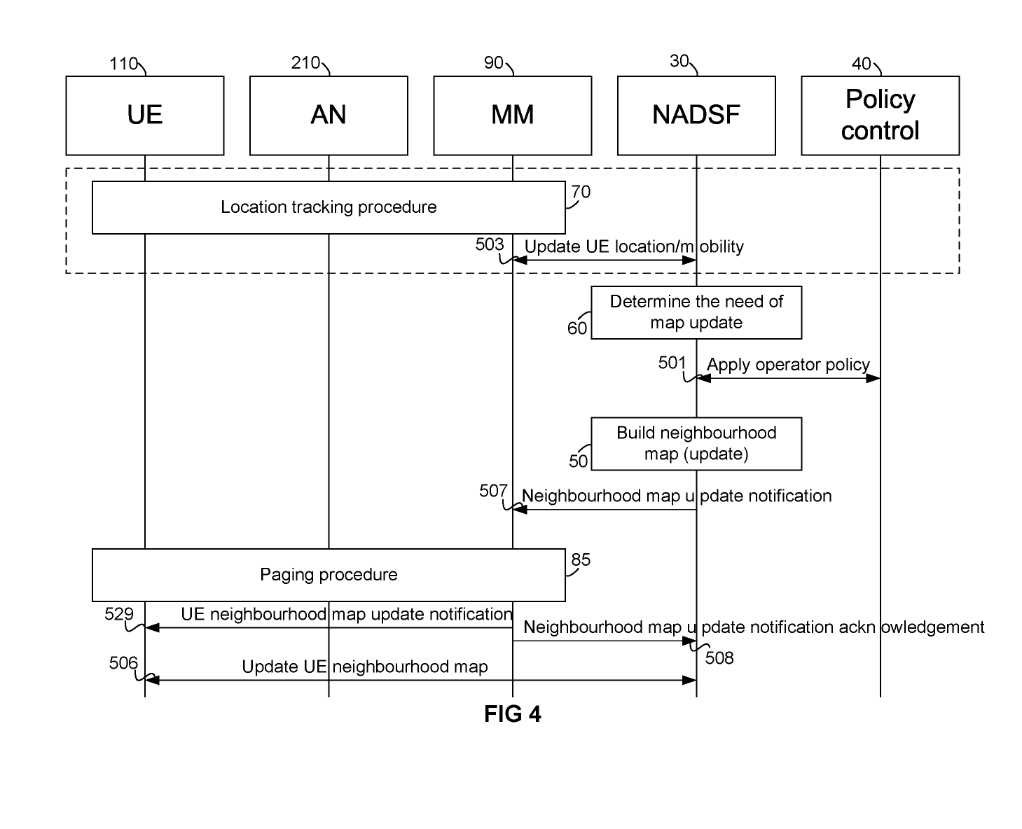

FIG. 4 illustrates a signal flow describing an alternate network-initiated neighborhood map update procedure (for push mode), according to an embodiment, which is suitable when the UE 110 is in CN idle mode. At step 1, the NADSF 30 determines the need to perform a UE 110 neighborhood map update according to the UE location and mobility information reported from the MM 90 function (which is signaled by the update UE location/mobility message 503). At step 2, the NADSF 30 can optionally obtain and apply operator policy (from the Policy Control 40 function via the apply operator policy message 501), which may restrict the UE's visibility of its neighborhood. The NADSF 30 requests an operator policy update if it determines the UE's map requires an update (performed by the determine the need of map update procedure 60). At step 3, the NADSF 30 updates neighborhood map of the UE according to UE location, UE mobility and operator policy using the Build neighborhood map (update) 50 function. At step 4, the NADSF 30 sends a UE neighborhood map update notification to the MM 90 function. At step 5, the MM 90 function wakes up the UE 110 via the AN 210 through a paging procedure 85. It should be appreciated that paging procedure 85 can be considered a CN paging procedure initiated by the MM 90. At step 6, the MM 90 function acknowledges to the NADSF 30 the delivery of the neighborhood map update notification via the neighborhood map update notification acknowledgement 508. MM 90 also notifies the UE of a UE neighborhood map update via the UE neighborhood map update notification 529. This message triggers the NADSF 30 to start updating UE 110's neighborhood map. At step 7, the NADSF 30 updates the UE 110 with the latest neighborhood map via the Update UE neighborhood map 506.

In some embodiments the UE does not simply rely on the information in the map to determine which cells it can connect with. In some embodiments the UE can use information in the map or it can dynamically check PCI and the map area ID contained in the MIB to determine which cells can be used. It should be appreciated that in some embodiments, the AN transmits the MIB to all UEs connected to it, which can be in the form of a broadcast.

Network discovery and selection in EPS networks (after PLMN selection) comprises cell selection and reselection. In some cases, the UE reselects a suitable cell based on constant measurements performed while in idle mode

In EPS systems, the UE needs to be synchronized with the cell before it can listen to and measure the cell's reference signals. After the synchronization, the UE locate the cell's reference signal which, based on the reference signal's extracted power and quality, is used to determine which cells to proceed with for performing cell (re)selection. For such a cell, the UE decodes system information of the cell, e.g. MIB and SIBs and decide whether to select the cell to camp on. Once the UE has reselected and camped on a cell, it listens to paging messages and establishes uplink transmissions as needed.

However the EPS requirement that the UE uses a measurement-based network discovery and selection process is neither time nor energy efficient. A measurement-based process wastes both time and energy in scenarios where strong macro cell reference signals interfere with small cell reference signals or where multiple RATs and multiple carrier bands co-exist.

Therefore, embodiments are discussed herein that are more time and energy efficient. Some embodiments allow access to both 3GPP and non-3GPP access nodes. Some embodiments use operator policy to control UE access to certain parts of the network.

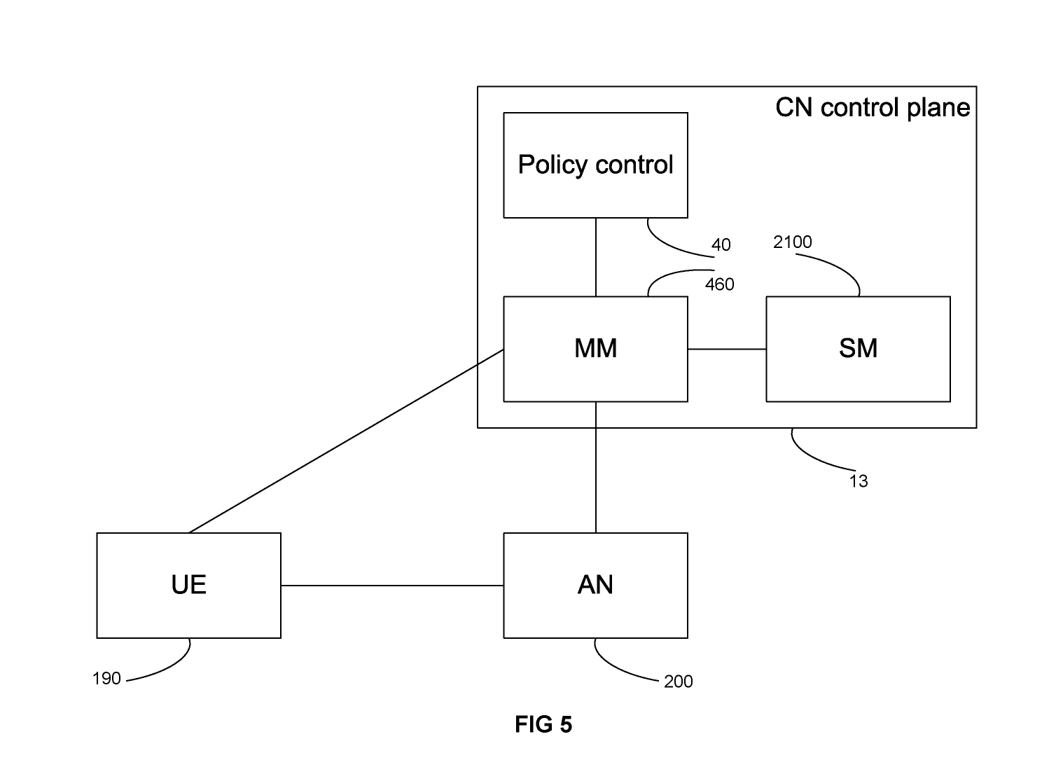

Certain embodiments use positioning techniques such as Location-Assisted Network Discovery and Selection (LANDS) to perform network discovery and cell reselection. An example LANDS embodiment is shown in FIG. 5. In this embodiment, the control plane (shown as CN control plane 13) includes a Policy control function 40, MM 460, and session management function SM 2100. UE 190 physically connects to MM 460 via AN 200. However, FIG. 5 also shows a logical connection between MM 460 and UE 190. This logical connection is shown to illustrate that the MM uses the UE's location when determining which cells are included in the neighborhood map.

LANDS assumes that traditional measurement-based cell selection is applied during UE initial attach as a bootstrapping technique or after the UE leaves the current map area as a fault-tolerance technique. LANDS requires the network provides a neighborhood map to an idle UE. This neighborhood map defines the map area of the UE based on operator policy. This map is updated by the network changes it mobility pattern or is about to leave the current map area.

The map area defined by the neighborhood map includes a list of cells. It covers an area as small as a few hundred square meters to as large as a few square kilometers. This area is configurable based on policy depending on such parameters as UE type, UE positioning accuracy, and UE mobility. The map contains each cell's ID and coverage area. The map also contains each cell's system information that is used by the UE to reselect and camp on the cell. This system information can contain RAT, frequency band, interface, power ramp rule, and code information.

As the UE moves, it reselects cell(s) with respect to its current location and the neighborhood map, as opposed to idle mode measurement. The UE camps on the selected cell, listens to paging messages and performs location update according to the cell information in the map (i.e. system information such as RAT, frequency band, interference, power ramp rule, code, etc.).

Depending on the set location update condition, different tracking granularities can be achieved. For example, if a location update is performed whenever the UE enters a new cell, location tracking is accurate at the routing area level. In this case, paging can be limited to a small region with respect to the UE's mobility. If location tracking is otherwise performed only when the UE is about to leave the current tracking area, tracking is done at the tracking area level, and paging is carried out in a region that may be as large as the tracking area.

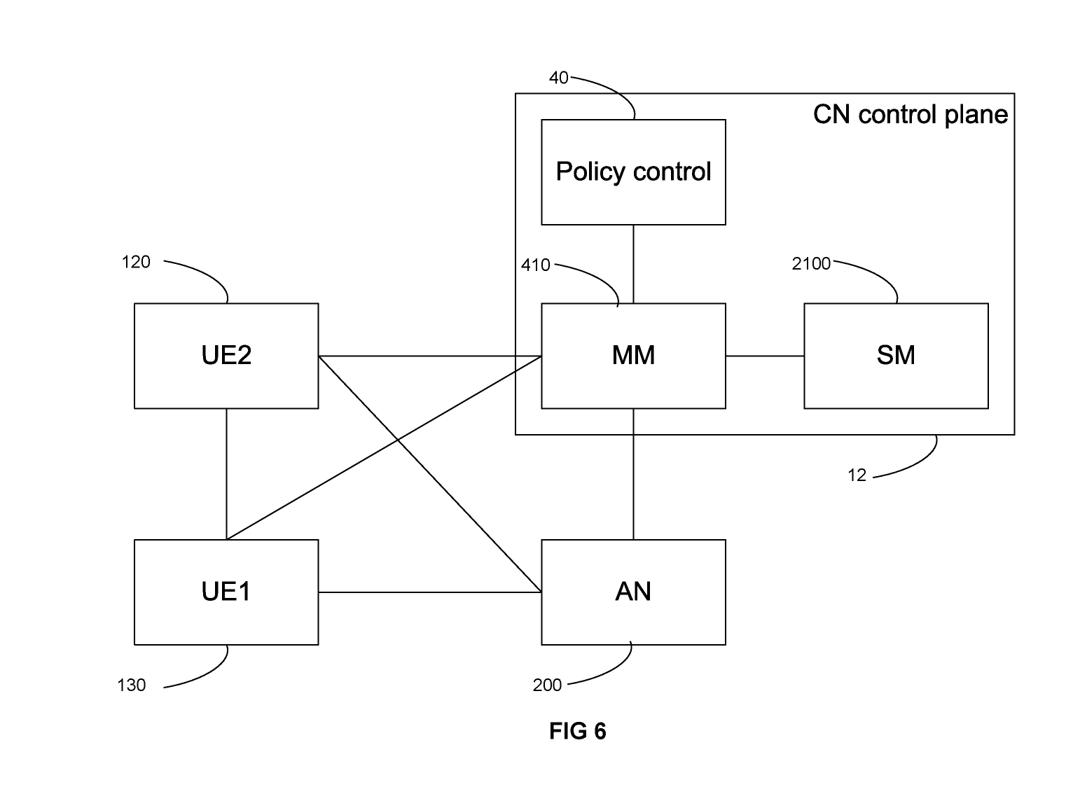

FIG. 6 illustrates an alternate embodiment assumed by LANDS where two UEs are connected to the network. In this embodiment, control plane functions (CN control plane 12) for policy control function 40, the MM 410, and the SM 2100. FIG. 6 also shows the connectivity between the MM 410, the AN 200, the UE1 130, and the UE2 120. It should be appreciated that these connections may be logical connections Furthermore, FIG. 6 also shows the logical connectivity between the MM 410, the UE1 130, and the UE2 120. These logical connections are shown to illuminate the fact that the MM 410 take the physical locations of UE1 and UE2 into account when it determines which ANs to include in the neighborhood map.

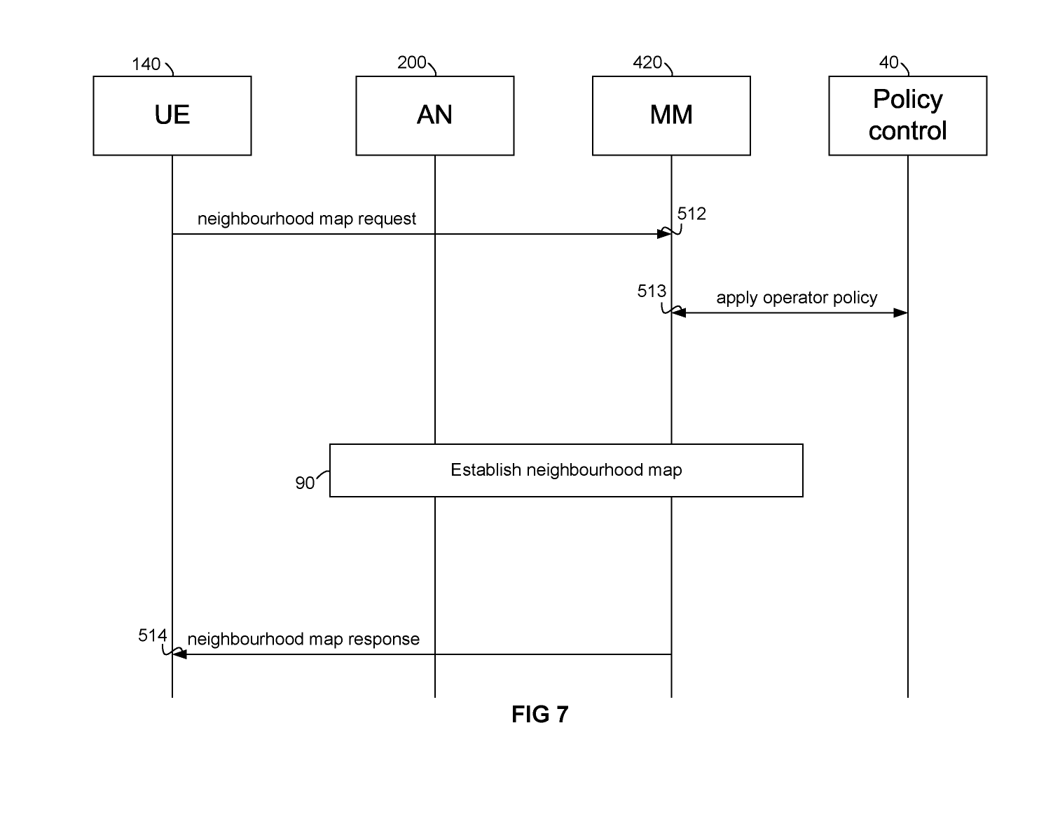

FIG. 7 illustrates the logical signal flow for an embodiment where UE 140 provides its location to MM 420. This embodiment is known as Network-based acquisition. UE 140 provides its location to MM 420 when it wants the MM to update the neighborhood map based on its current location. UE 140 provides its location to MM 420 via the neighborhood map request 512 signal. MM 420 uses the operator policy, received from the Policy control 40 function, when it builds a neighborhood map (performed using the establish neighborhood map 90 function). MM 420 then provides UE 140 with this updated neighborhood map.

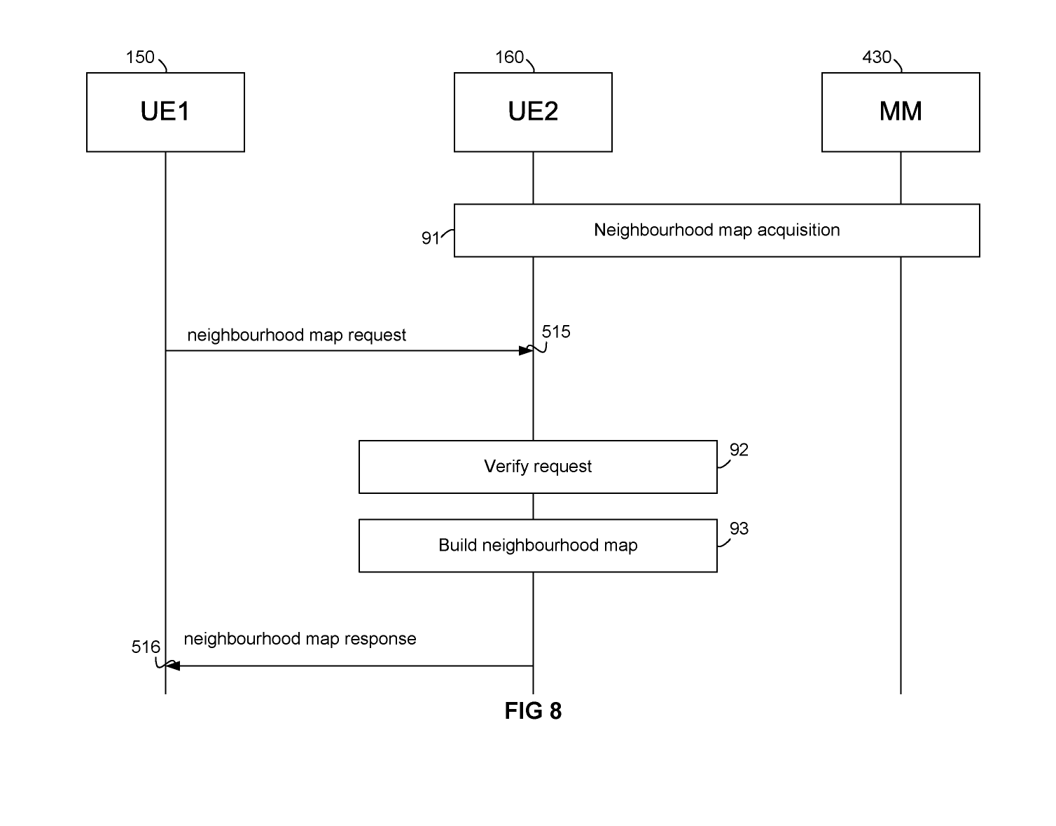

FIG. 8 illustrates the signal flow for an embodiment where two UEs, in this case the UE1 150 and the UE2 160, are connected to the network. In this embodiment, known as D2D based acquisition, UE2 and MM 430 share a logical connection (shown as the Neighborhood map acquisition 91 function) which UE2 uses to obtain the information needed to create a new neighborhood map. The embodiment described in FIG. 7 shows a physical connection between UE1 and UE2, labeled as the neighborhood map request 515 signal, that UE1 uses to request an updated neighborhood map from UE2. UE2 verifies UE1's request using the Verify request 92 function, builds a neighborhood map using the Build neighborhood map 93 function, and passes this new map to UE1 via the neighborhood map response 516 signal.

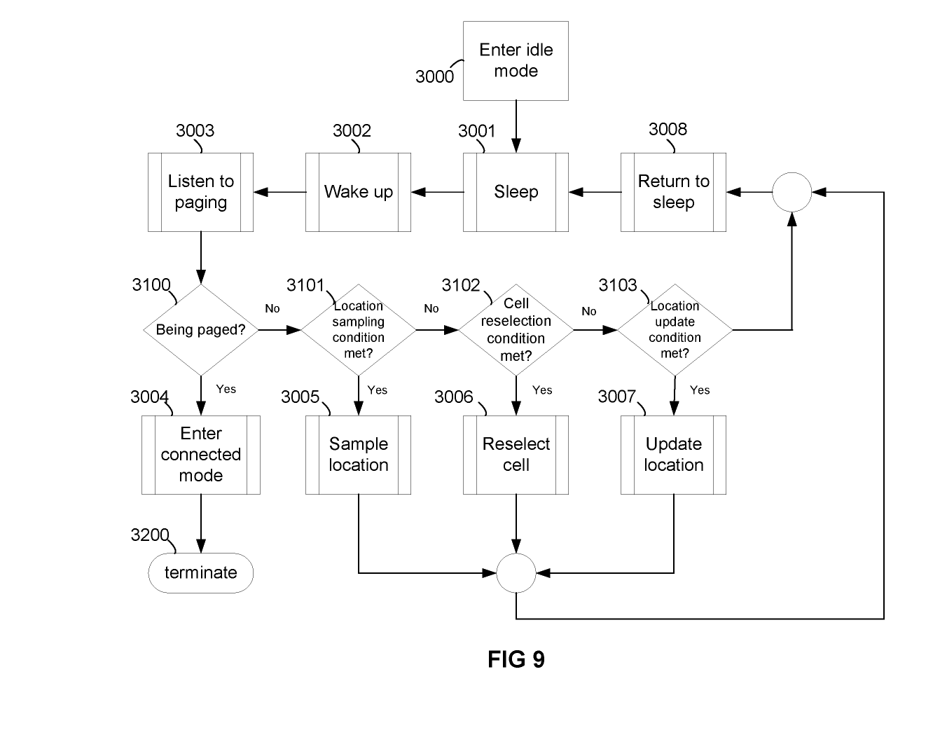

FIG. 9 is a flowchart illustrating a process for a UE transitioning from idle mode. In such a process the UE can transition from idle mode into connected mode or to sample its location, or to reselect a cell, or to update its location. In this context, the flowchart shown in FIG. 8 can be considered an UE Idle Mode Procedure. As shown in FIG. 9, the UE enters idle mode 3000. The UE then enters sleep mode Sleep 3001. The UE wakes up 3002 and listens for paging 3003. The UE determines if it is being paged 3100. If the UE is being paged, it enters connection mode 3004 and terminates this idle mode procedure 3200. If the UE is not being paged, it determines if its location sampling condition is being met 3101. If the location sampling is met, the UE samples its location 3005 and returns to sleep mode 3008. If the location sampling is not met, the UE determines if its reselection condition has been met 3102. If it has, the UE reselects the cell 3006 and returns to sleep mode 3008. If the reselection condition has not been met 3102, the UE determines if its location update condition has been met 3103. If it has, the UE updates its location 3007 and returns to sleep mode 3008. If it hasn't, the UE goes back to sleep 3008. It should be appreciated that in order to perform the update location step 3007, the UE temporarily connects to the network to perform the location update before returning to sleep 3008. For simplicity this temporary transition to the connected state is not shown. It should be appreciated that in some embodiments the conditions 3101, 3102 and 3103 need not be interdependent as shown. In other words, in some embodiments checking these conditions does not depend on a “no” result from the prior condition check, and can be checked independently and in different orders.

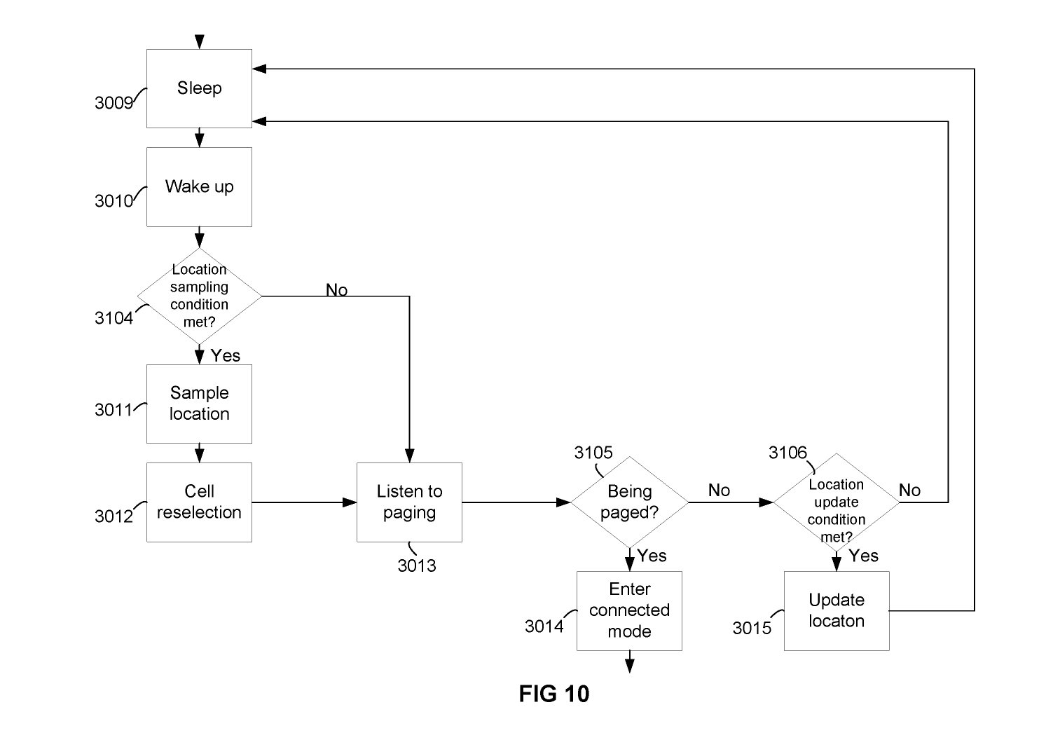

FIG. 10 illustrates an alternate UE idle procedure. The UE enters sleep mode 3009. The UE wakes up after a Discontinuous Reception (DRX) cycle and checks its location sampling condition 3104. If the location sampling condition is met, the UE samples its location 3011, followed by a Cell reselection 3012 to reselect the cell according to its current location and the neighborhood map. The newly selected cell may be the same cell as the old cell. The UE then listens to paging messages within the current cell 3013. The UE determines if is being paged 3105. If the UE determines it is being paged, it enters into connected mode 3014 and may also optionally perform DL measurement-based cell reselection. If the UE determines that it isn't being paged, it checks its location update condition 3106. If the location update condition is met, the UE performs a location update 3015 before entering sleep mode. If the location update condition isn't met, the UE goes into sleep mode without performing any other actions.

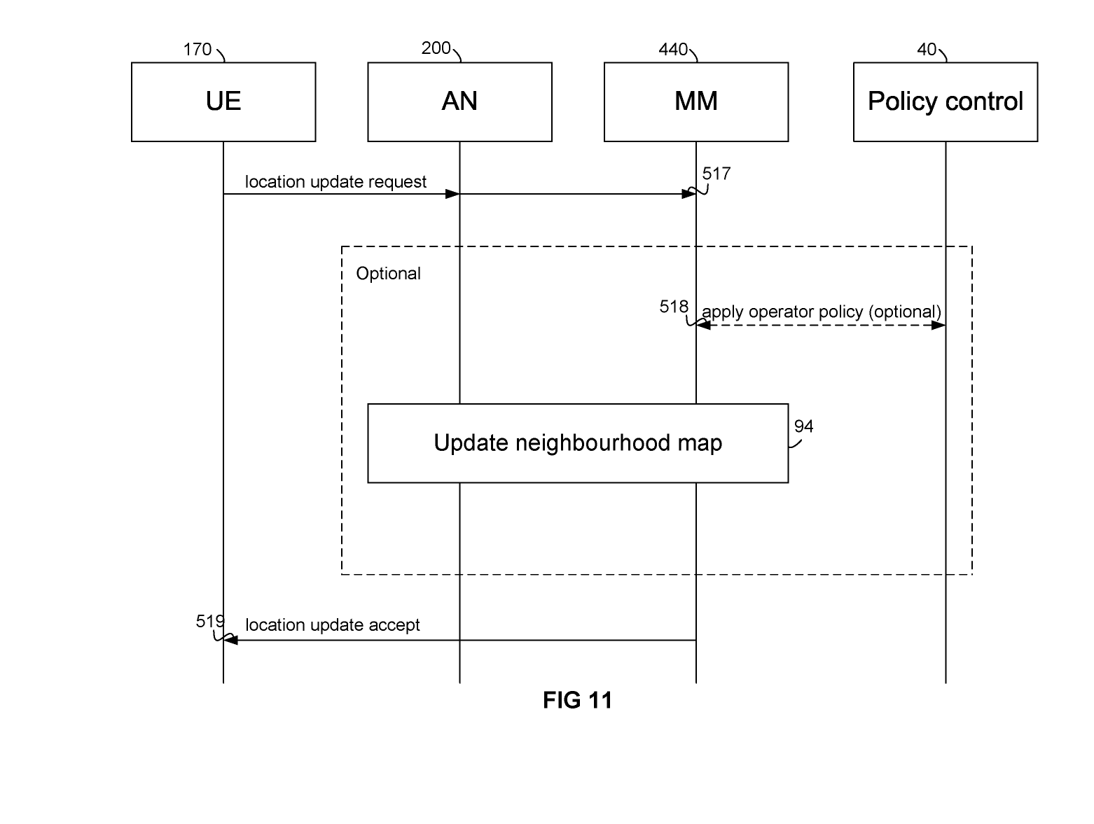

FIG. 11 illustrates an embodiment where the MM 440 can optionally use the operator policy control when it updates the neighborhood map after a location update request from the UE. In this embodiment, UE 170 requests a new neighborhood map after providing its location to MM 440 via AN 200. UE 170 provides its location to MM 440 using the location update request 517 signal. MM 440 can optionally receive the operator policy from the Policy control function 40. If MM 440 does receive the operator policy, the MM can use this policy to update the neighborhood map 94. MM 440 then provides UE 170 with the updated neighborhood map via the Location update accept message 519. In the embodiment shown in FIG. 11 the neighborhood map update request is integrated with the location update request, i.e. the location update request 517 includes the map update request. In some embodiments, the UE need not include the map update request. In such embodiments, the MM determines whether to update the neighborhood map to the UE according to UE's location report.

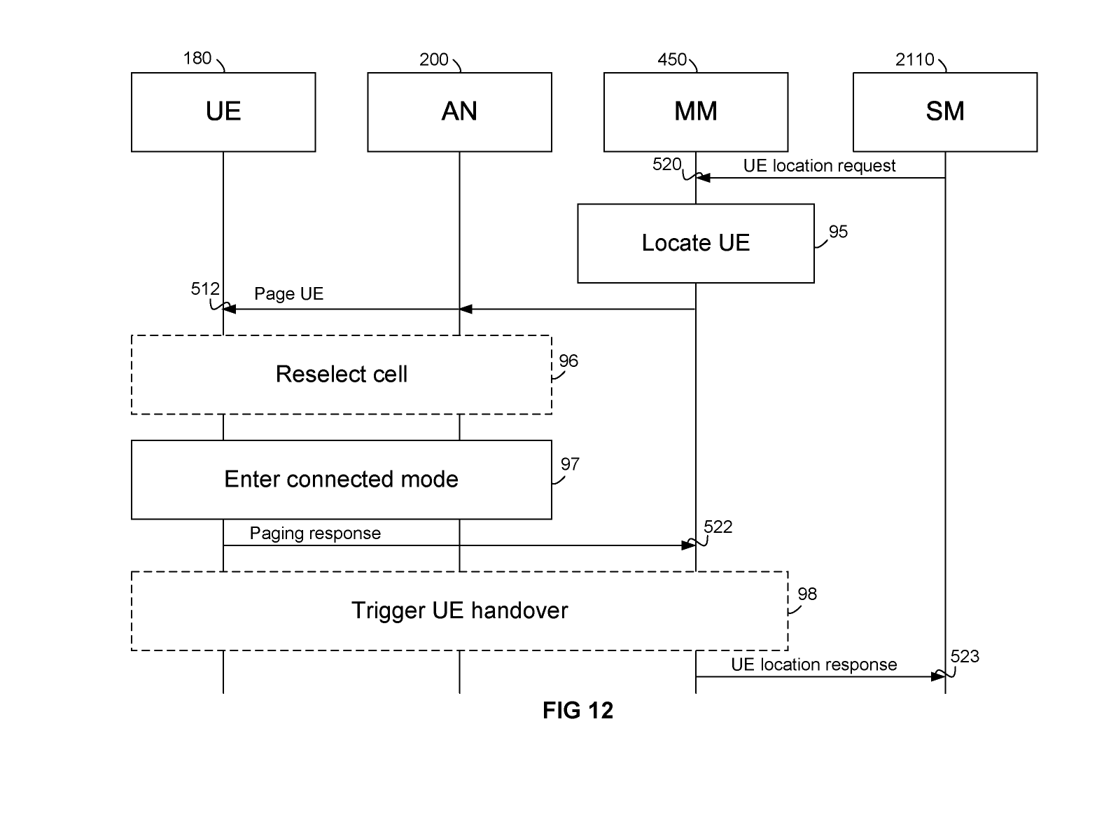

FIG. 12 illustrates the signal flow for an embodiment where the SM requests the MM locate the UE and request the UE transition from idle to connected mode for example, for a downlink transmission. FIG. 11 shows SM 2110 requesting MM 450 locate the UE, via the UE location request 520, so that the UE can transition from idle to connected mode. MM 450 uses the Locate UE procedure 95 along with the Page UE message 521 to page UE 180. In some embodiments this procedure narrows down the paging area from the tracking area based on such factors as last known location and known mobility. UE 180 implements an Enter connected mode procedure 97 with AN 200, to transition from idle to connected mode. UE 180 can optionally implement a reselect cell procedure 96 with the access network, to reselect the cell when it enters connected mode. UE 180 informs MM 450 that it has entered connected mode via the Paging response 522 signal. UE 180 can also optionally implement a Trigger UE handover procedure 98 with both AN 200 and MM 450, to cause a handover operation. MM 450 then informs SM 2110 that UE 180 has transitioned from idle to connected mode via the UE location response 523 signal.

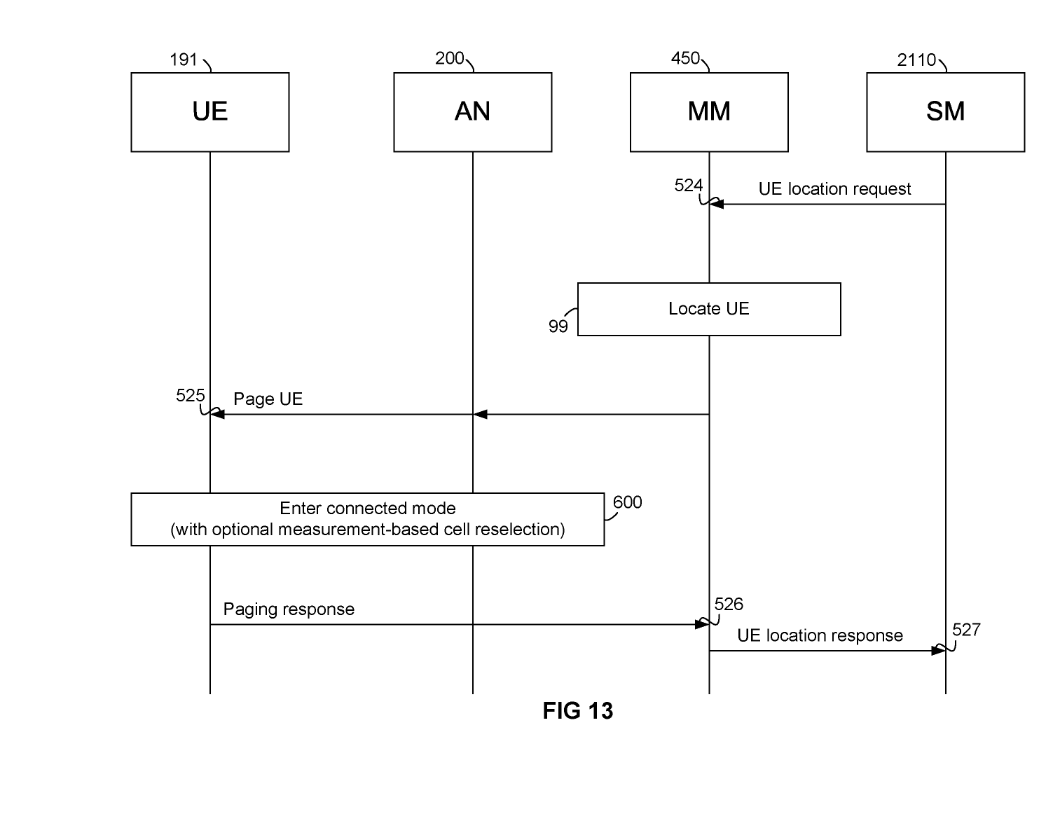

FIG. 13 illustrates the signal flow for an alternate procedure used to locate an idle UE (upon DL session). SM 2110 sends MM 450 a UE location request via the UE location request 524 signal. MM 450 uses the Locate UE 99 function to find the paging area (which may be equal or smaller than the tracking area) of UE 191. MM 450 pages UE 191 via AN 200, which is within the tracking area, using the Page UE 525 signal. After receiving the paging message, the UE 191 uses the Enter connected mode (with optional measurement-based cell reselection) 600 function to enter into connected mode. When reconnecting, the UE may optionally perform DL measurement based cell reselection. Multiple cells may be reselected. Note that UE 191 shares the Enter connected mode (with optional measurement-based cell reselection) 600 function with AN 200 so that the UE knows which AN to connect with. UE 191 sends a paging response to the MM 450 via the paging response 526 signal. The MM 450 sends a UE location response to the SM 2110 via the UE location response 527 signal. This response includes the cell ID of the UE.

Embodiments can reduce “system information overhead” transmitted over-the-air (e.g. in a SIB) which can reduce access delays and excessive consumption of UE battery power. Such embodiments make use of the fact that a lot of the System Information (SI) is semi-static. Accordingly SI for the cells within a given service area can be downloaded (as part of the above discussed maps) to the UE during an initial network access with subsequent updates on an as-required basis. The UE can determine the SI for a cell by matching a Physical Cell Id to one of its entries defined in the service area. For example, a 3GPP cell in the map is indexed by its PCI. The UE can obtain the cell-specific information for a cell from the matching PCI. In some embodiments this can also be extended to non-3GPP RATs.

Accordingly, some embodiments can download SI for cells within a given service area, for example during network attachment. The “service area” may be defined by geolocation information, exploiting capabilities in the UE (e.g. GPS) for determining location in some embodiments. The SI includes information normally found in SIBs, indexed by PCI; during cell (re-)selection, UE obtains synch and determines PCI (in some embodiments cells in the maps are indexed by PCI). If a matching PCI is found in its cell list, UE acquires MIB to determine if SI information in its cell list is valid. The MIB includes: (the least significant bits of) an epoch indicating the latest version of SIB information for the cell (a mismatch requires over-the-air acquisition of SIB); an indication of whether access barring (in some or any form) is active in the cell (if so, appropriate SIB may need to be acquired).

Accordingly, in some embodiments such a method and system can reduce energy and overhead information by reducing the need for a UE to decode every SIB from overhead signaling for every cell for every cell reselection. Instead the UE can determine information from PCI information received by the map download and update procedures described herein. In some embodiments the UE retrieves dynamic information from the MIB to determine what SIB information needs to be decoded. Furthermore, in some embodiments, this can be applied for both 3GPP cells and non-3GPP cells.

The above description is made by way of example only, and many alternatives or variations can be made without departing from the scope of the invention, some of which will now be discussed.

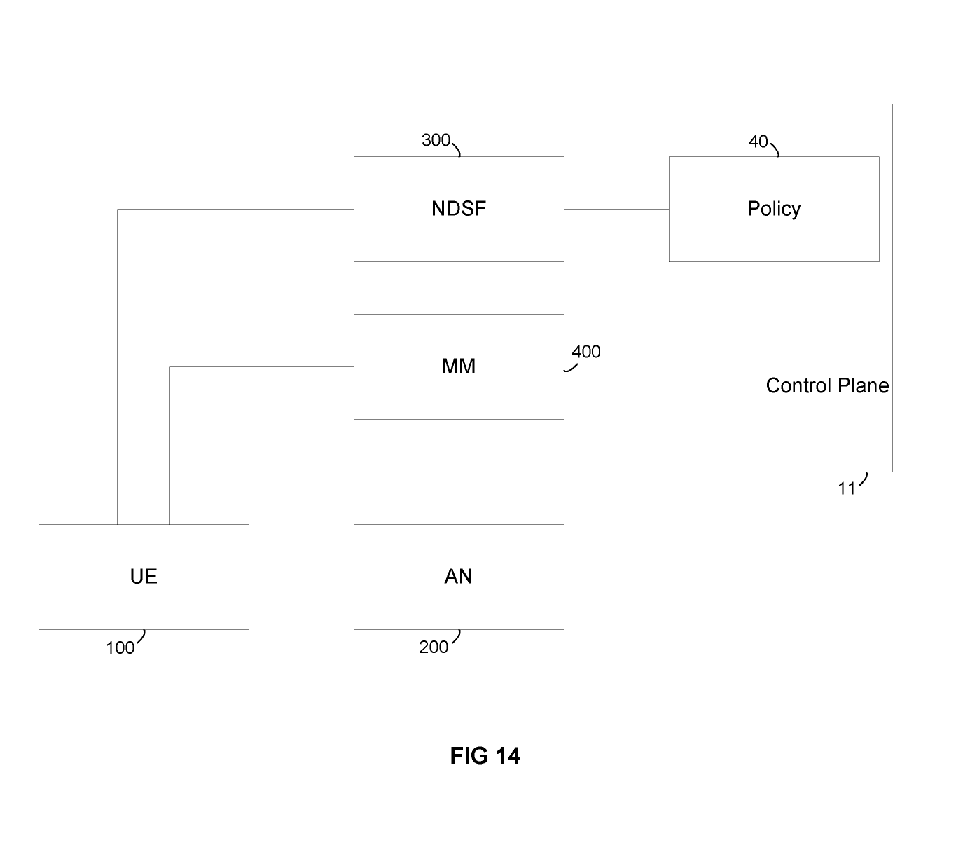

FIG. 14 illustrates a variation of the network architecture illustrated in FIG. 1, according to an embodiment. FIG. 14 illustrates control plane functions instantiated in Control Plane 11, including an MM 400 function, a network discovery and selection function (NDSF 300), also known as a NADSF, and a policy 40 function.

Embodiments provide a network discovery and selection function (NDSF 300) in the control plane to assist UE 100 in performing network discovery and selection (NDS) to determine which RAT to use and to which AN 200 it should connect The assistance offered by the NDSF 300 can take the form of ‘Neighborhood Map’. A neighborhood map contains a list of cells (3GPP or non-3GPP). Depending on the configuration, the neighborhood map can include associated information related to NDS, which may include, but is not limited to, any of the following:
Network discovery information: e.g. network identifier (e.g. PLMN ID, WLAN SSID), RAT type, multi-RAT, RAT-specific information (e.g. one or more carrier frequencies), etc.
Inter-RAT mobility policy: e.g. RAT priority when a single RAT is to be used, etc.
Inter-RAT routing policy: e.g. RAT restriction, or preferred RAT combination, when multiple RATs can be used at the same time, etc.
Inter-network routing policy: e.g. PLMN restriction, or preferred PLMN combination, when multiple PLMN can be selected simultaneously
3GPP access network selection policy: e.g. PLMN in priority order, service/slice support and associated RAT, service/slice equivalency, etc.
Non-3GPP access network selection policy: e.g. WLAN in priority order, minimum backhaul capacity, backend PLMN ID, etc.
Rule/policy validity condition: e.g. when and where (within the map).
Rule/policy priority (in case of contradiction or contention): e.g. 3GPP vs. Non-3GPP, a first RAT vs. a second RAT, HPLMN vs. VPLMN, etc.
3GPP access network assistance information: e.g. cell specific parameters, location, coverage, etc.
Non-3GPP access network assistance information: e.g. WLAN parameters, location, coverage, etc.

In some embodiments the rule/policy can allow for conditional decisions made by the UE.

In some embodiments, the neighborhood map may be associated with a geographic boundary. In some embodiments, the neighborhood map, or the associated information, can include, or be associated with, NDS policy data provided by the policy control function. In some embodiments, the neighborhood map, or the associated information can contain non-policy data, for example, 3GPP cell-specific parameters for assisting UE in accessing the network. In this specification, the term neighborhood map should be understood to optionally include the associated information, but it should be appreciated that the NDSF and/or the policy function can be configured to bundle them together or separate them.

The UE may obtain the neighborhood map or a neighborhood map update through a pull-mode procedure or a push-mode procedure. In the pull-mode procedure, the UE sends a request to the NDSF to send the map (or an update). In the push-mode procedure, the NDSF informs the UE that there is a neighborhood map (update) or prompts the UE to acquire neighborhood map (update). The neighborhood map is generated by the NDSF according to operator policy, UE capabilities, UE mobility and UE location. Further, in some embodiments, such a neighborhood map can be dynamically adjusted by updates in order to provide the UE with valid up-to-date maps for network assisted NDS. For example, the neighborhood map can be updated periodically, or in response to UE movement (for example the UE approaches the boundary of the map or moves out of the map area) or as the map content validity changes. It should be noted that in some embodiments the UE can be given an address in the notification that would resolve to either an internal network function (e.g. a UPF) that is representative of the PCF/NADSF in the User Plane (UP), or an address that resolves to a node in a data network (DN) connected to the core network. A UPF, acting as a UPGW, can act as a gateway between the CN and the DN.

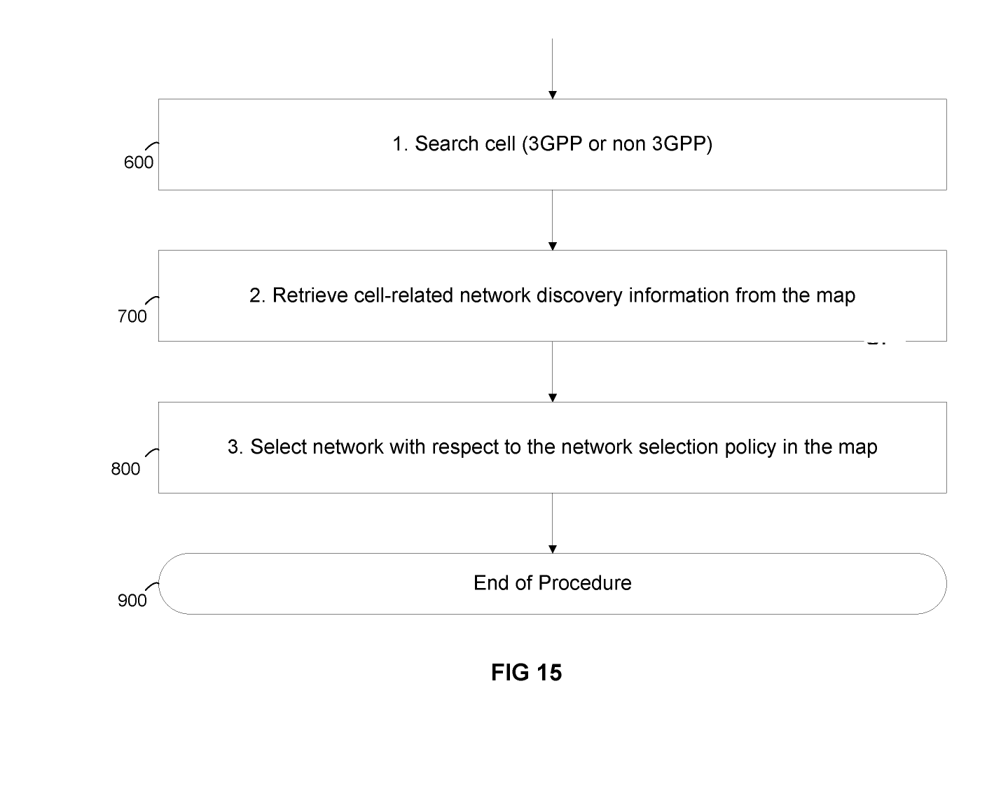

FIG. 15 illustrates an NDS procedure executed by (the processor of) the UE, according to an embodiment. This procedure includes, at step 1, the UE searches for cell signals and identifies cells (3GPP or non 3GPP) using the Search cell (3GPP or non 3GPP) step 600. This can include detecting cell signals and decoding necessary cell system information such as the MIB of 3GPP cells to obtain cell identifier such as PCI (physical cell identifier), Cell ID, SSID, etc. At step 2, the UE retrieves cell-related network discovery information from the most recently received neighborhood map (or map update) and associated information via the Retrieve cell-related network discovery information from the MAP step 700. For example, the UE can extract NDS related information from the map using the cell identifier (e,g, the PCI). UE location information may also be used to narrow down the information retrieval from the map (e.g. the UE may only extract NDS information related to the area close to the UE location). At step 3 the UE selects the network (i.e. a cell within a network), which may be a different network (or even a different type of network (e.g. different RAT)), based on the policy information included in the Map via the Select network with respect to the network selection policy in the map step 800. For example, a UE connected to a 3GPP network may switch to a Wi-Fi network. In summary, in order for a UE to select a network, the UE first detects the network (i.e. a cell of the network). The UE then extracts network information from a received neighborhood map, using the detected cell identifier(s). Further, the UE can extract, from the map, network selection policies related to the network and other networks discovered. Then the UE selects a network to connect to according to the extracted policy. While not shown in the figure, in some embodiments the procedure can further include selecting cells based on the received map (which may belong to the same network in the case of map update). In some embodiments the UE can utilize the map to determine if further information needs to be decoded during any cell reselection and only decodes further information as needed. In some embodiments, the location information may take the form of area ID that can be extracted from the MIB and the cell selection procedure use a combination of the PCI and this extracted area ID. However, in some embodiments, the cell selection is based on a combination of locally determined location information and the PCI. The network discovery and selection performed by the UE procedure shown in FIG. 15 is completed when at End 900.

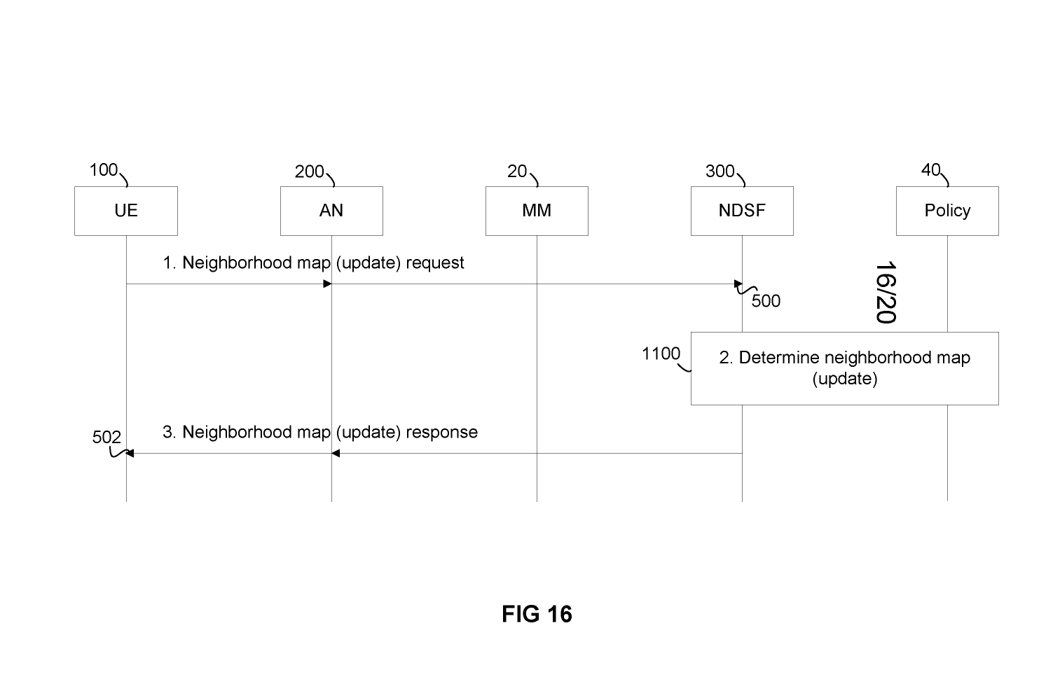

FIG. 16 illustrates a signal flow describing the UE-initiated neighborhood map acquisition/update procedure (pull mode), according to an embodiment. Such a procedure can provide an initial neighborhood map, as well as provide updates to the map. At step 1, the UE 100 sends a neighborhood map (update) request 500 to the NDSF 300 via the AN 200. The message may contain UE capabilities, UE mobility, UE location information, etc. At step 2, the NDSF 300, in conjunction with the policy 40 function, determines the neighborhood map (or determines neighborhood map update information) for the UE according to the UE request and operator policy via the Determine neighborhood map (update) step 1100. For example, the operator policy may restrict the UE's visibility to its neighborhood (e.g., based on security/privacy issues, reliability issues, loading issues, etc.). Accordingly in some embodiments the policy function provides the related NDS policy data to the NDSF, and the NDSF includes this policy information in the map. At step 3, the NDSF 300 sends a neighborhood map (update) response to the UE, including the neighborhood map (update) via AN 200 using the neighborhood map (update) response message 502. As discussed below with reference to FIG. 18, the MM20 may be involved depending on whether the map is sent via control plane signaling or user plane traffic.

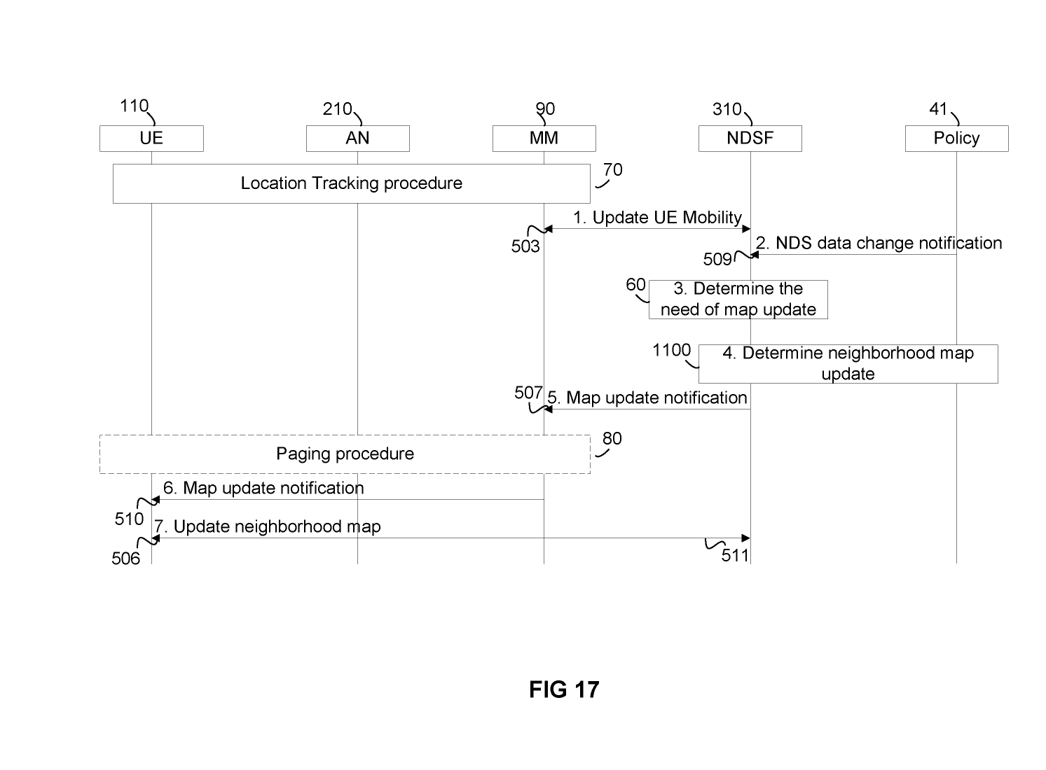

FIG. 17 illustrates a signal flow of an example implementation of an NDSF initiated neighborhood map update procedure (for push mode), according to another embodiment. It is assumed in this illustrated example that location tracking procedure (shown in FIG. 17 as the Location Tracking procedure 70) is engaged between the UE 110, the AN 210 and the MM 90 function and that the MM 90 function sends updates about the UE location and mobility to the NDSF 310 periodically or when necessary depending on mobility event subscription as described above. At step 1, the NDSF 310 receives a trigger (the Update UE Mobility message 503) from the MM 90 function indicating that UE 110 has moved to a new location or showed a new mobility pattern. At step 2, the NDSF 310 receives a NDS policy change notification from Policy 41 via the NDS data change notification message 509. It is noted that although listed as steps 1 and 2 for ease of reference, receipt of either of these messages can serve as a trigger for the NDSF to undertake step 3. At step 3, the NDSF 310 determines the need for performing UE 110 neighborhood map update based on the UE mobility and/or the NDS policy change notification using the Determine the need of map update step 60. At step 4, the NADSF 310 determines a neighborhood map (update) for the UE according to the UE location, UE mobility and operator policy using the Determine neighborhood map update step 1100. At step 5 the NDSF 310 sends a neighborhood map update notification 507 signal to the MM 90 function. The message may include the neighborhood map update or may only indicate that the UE 110 should update its map. At step 6, the MM 90 function forwards the notification to the UE 110 (via the AN 210). A paging procedure 80 may be used to wake up the UE 110 before the notification is sent. At step 7, the UE 110 sends an acknowledgement to the NDSF 310 via the Update neighborhood map message 511 and, if necessary, initiates a transfer of the updated map from the NDSF via the Update neighborhood map message 506. As stated above, and discussed in more detail below with reference to FIG. 18, the transfer may be based on a user plane approach where the NDSF is treated as a server and accessed through a UPF. In some embodiments, the transfer may be based on a control plane approach, where MM acts as message relay (this is similar to the UE-initiated map acquisition).

In some embodiments to enable efficient cell (re)selection, the neighborhood map contains a list of cells, each associated with static or semi-static SI (S-SI) that are normally broadcasted in SIBs and related to cell (re)selection. Each cell in the map can be associated with a PCI, and optionally a map area identifier, such that the PCI is unique within the identified map area. In the cell search step of cell (re)selection, the UE listens to cell synchronization signal and obtains PCI. It then locates reference signal, measures RSRP/RSRQ, and decodes MIB. The UE can then extracts the cell's system information from the neighborhood map using the observed PCI, as opposed to decoding them over the air. Afterwards, the UE proceeds with the subsequent steps for cell (re)selection.

In some situations, the PCI may not be unique. However, the PCI values in a small region are very likely unique (as network operators will avoid having two adjacent or close by cells using the same PCI). Accordingly in some embodiments, in order to extract the correct information from the map, the UE can utilize knowledge of its location in combination with the PCI to identify the information in the map. Accordingly, in some embodiments, the UE will only evaluate the cells around the UE location in a small region (whose size may be determined according to the possible coverage of a cell). Alternatively, for embodiments in which a map area ID is included in the MIB, the UE can obtain the map area ID and use it together with the PCI as unique identifier to extract cell-specific information from the map. In some embodiments, the area identification information (e.g., the map area ID) defines a region including access nodes, with each access node within the region having a unique physical cell identifier (PCI). It is noted that due to a limited number of PCIs, access nodes in large networks do not always have unique PCIs.

In some embodiments the S-SI may be updated, either at fixed intervals or when needed. Accordingly, in some embodiments the UE should be able to detect any S-SI update and obtain the updated portion over the air only when necessary. In some embodiments this includes assigning an overall version number to cell-specific S-SI and including it in the neighborhood map. In some embodiments the MIB includes the latest S-SI version number. The S-SI version number may be maintained in a hash code associated with the S-SI, in a hash code of the combination of individual SIBs' version number, or a number that changes whenever the S-SI changes. When the UE decodes the MIB and sees a version number mismatch, the UE can decode the SIB designated to carry the version number of individual SIBs to identify exactly which SIBs are update. The UE can then proceed to decode those SIBs to obtain the S-SI updates in order to update the neighborhood map.

In some embodiments the MIB may carry an indication about any dynamic system information (e.g. whether access control is applied or not), enabling UE to know whether to proceed to decode respective SIBs to obtain the dynamic system information.

Accordingly, in some embodiments the MIB carries the latest S-SI version number and an access control indicator. In some embodiments MIB may further carries a map area ID indicating the map area where the cell's PCI is unique. In some embodiments UE decodes MIB and extracts the S-SI version number and dynamic system information indicators. In some embodiments the UE extracts S-SI from the neighborhood map rather than decoding it over the air unless MIB indicates S-SI update (S-SI version number mismatch). In some embodiments the UE decodes only relevant SIBs to obtain the updated portion of the S-SI. In some embodiments the UE identifies SIB update by decoding the SIB designated to carrying the SIB version numbers and checking version number mismatch. In some embodiments if dynamic system information indicators indicate that access controls are in effect, UE decodes relevant SIBs to obtain dynamic access control (e.g. access class barring) information.

In some embodiments described herein the NADSF/NDSF can perform the update procedure independent of (e.g., does not rely on) the UE knowing or communicating its location. In other embodiments, the MM function can perform NADS/NDS updates and assumes the UE can determine its location. FIG. 18 illustrates two approaches for a UE to receive a map, or a map update, according to embodiments. The top portion of the figure (above the dotted line) illustrates an embodiment utilizing control plane signaling. The bottom portion of the figure (below the dotted line) illustrates an embodiment where the NADSF is treated as a server and accessed as a user plane function. For the user plane approach, the UE 110 requests a map from the NADSF 1250, via AN 210, using the neighborhood map request 534. The NADSF 1250 passes the map response to UE 110, via AN 210, using the neighborhood map response 535 signal. The UE requests and receives maps from the NADSF 1250 via the N3 interface 532. It should be appreciated that, optionally N3 and N6 are utilized, if PCF appears as a data network (DN) function. For the control plane approach, the NADSF 1250 passes the map update notification to the UE 110 in two steps. The first step is to pass the map update notification 533 signal to the MM 90 via the N15 interface 531. The second step is for the MM 90 to pass the map update notification 536 signal to UE 110 via the N1 interface 530. It should be appreciated that in this embodiment, the PCF 1200 instantiates the NADSF 1250.

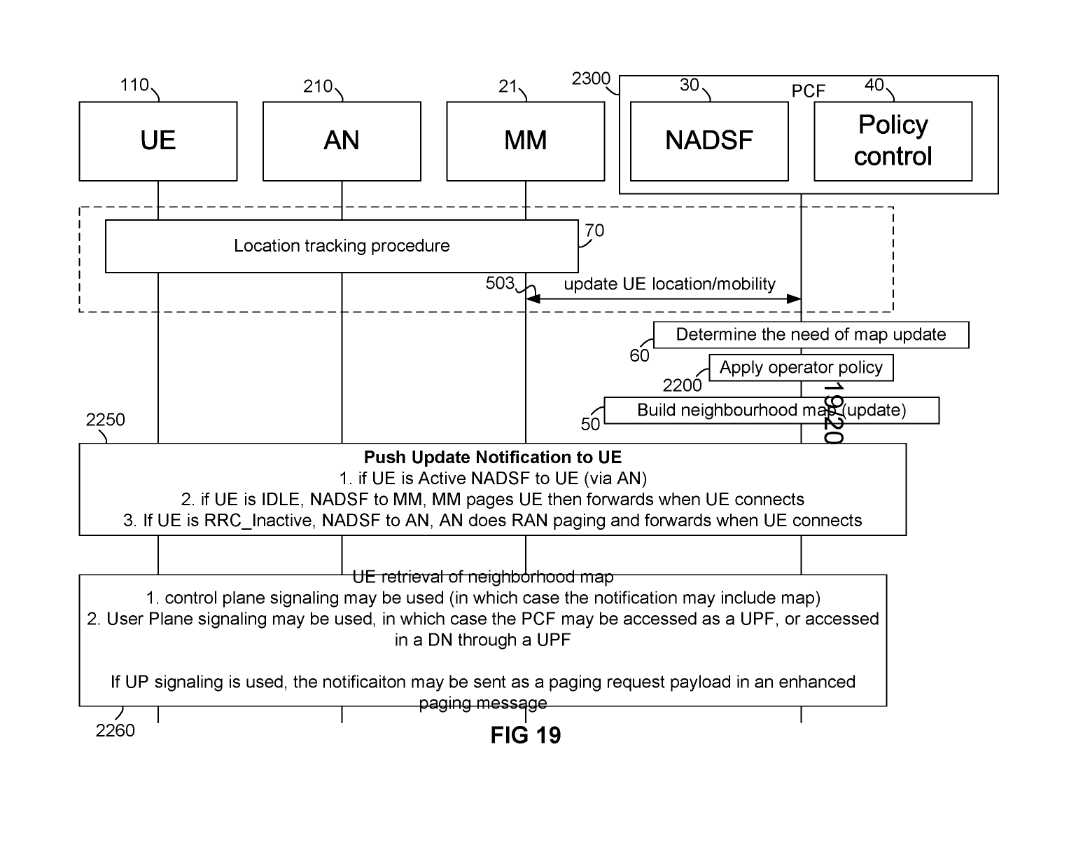

FIG. 19 illustrates a push update notification to the UE according to an embodiment. The Location tracking procedure 70 is logically shared by UE 110, AN 210, and MM 21. When it is detected that the UE's location changes, and a map update is required, MM 21 notifies the PCF 2300 that UE 110 requires a new map via the update UE location/mobility 503 signal. It should be noted that the PCF 2300 can be comprised of the NADSF 30 and the Policy Control 40 functions. The PCF 2300 responds to the map update notification using the Determine the need of map update 60, Apply operator policy 2200, and Build neighborhood map (update) 50 functions. Function 2250 describes the method of performing a Push Update Notification to UE. In this method, the map is pushed to the UE from the NADSF, via MM and AN, when the UE is active. In this case, as the UE is active (i.e, connected, RAN paging is not needed). In the situation when the UE is idle, the map is passed by the NADSF to the MM. The MM then pages the UE and then forwards the map when the UE connects. In the situation where the UE is RRC_Inactive, the NADSF passes the map to the AN via MM and the AN does RAN paging and forwards the map when the UE connects. Function 2260 describes the UE retrieval of neighborhood map procedure. In this procedure, control plane signaling may be used. It should also be appreciated that when this occurs, notification may include map. User plane signaling may also be used where the PCF can be accessed as a UPF or accessed in a DN through a UPF. It should be appreciated that if UP signaling is used, the notification may be sent as a paging request payload in an enhanced paging message.

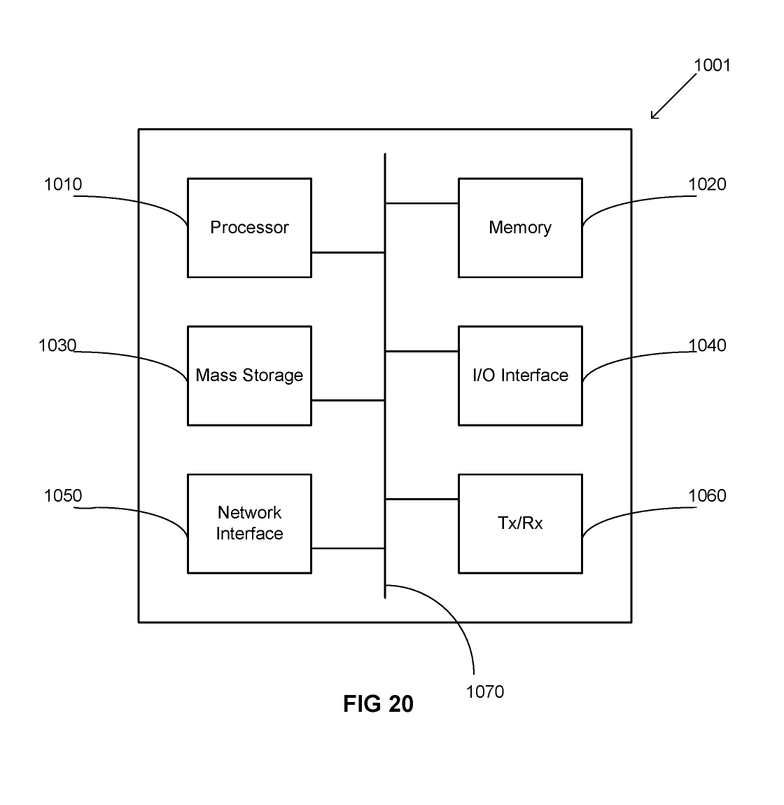

FIG. 20 is an exemplary block diagram of a processing system 1001 that may be used for implementing the various network functions. As shown in FIG. 9, processing system 1001 includes a processor 1010, working memory 1020, non-transitory storage 1030, network interface 1050, I/O interface 1040, and depending on the node type, a transceiver 1060, all of which are communicatively coupled via bi-directional bus 1070.

According to certain embodiments, all of the depicted elements may be utilized, or only a subset of the elements. Further, the processing system 1001 may contain multiple instances of certain elements, such as multiple processors, memories, or transceivers. Also, elements of processing system 1401 may be directly coupled to other components without the bi-directional bus.

The memory may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. According to certain embodiments, the memory or mass storage have recorded thereon statements and instructions executable by the processor for performing the aforementioned functions and steps.

The processing system 1001 can be used to implement a UE or host which executes the various network functions described herein, for example the AN, MM and the NADSF or NDSF.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can include the device memory as described above, or stored in removable memory such as compact disk read-only memory (CD-ROM), flash memory, or a removable hard disk. The software product includes a number of instructions that enable a computer device (computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

Those skilled in the art will appreciate that the above description supports a method for the generation of a network discovery map. The method can be by a Network Access Discovery and Selection Function (NADSF) associated with a core network. The method comprises generating a map associating a physical cell identifier and location information with system information associated with access nodes in a radio access network, for a UE, in accordance with a location associated with the UE; and transmitting the map for forwarding to the UE.

In an embodiment of this method, the step of generating a map is performed in response to receipt of an indication of receipt of a registration request associated with the UE. In a further embodiment, the step of generating a map comprises generating an update to a map previously provided to the UE, and wherein the step of generating is performed in response to receiving an indication of a map update event, and optionally the map update event is an event associated with the mobility of the UE. In an embodiment of the method, the method further comprises computing policy information for at least one of the UE and the area, wherein generating the map is performed in accordance with the computed policy information.

It will be further understood that the above description supports a method performed by a mobility management function comprising transmitting to an NADSF, a notification associated with UE mobility.

In an embodiment of this method, transmitting the notification is performed in response to detection of a change of UE location. In a further embodiment, transmitting the notification is performed in response to detection of a change in the mobility state of the UE and optionally the mobility state of the UE is selected from the group comprising high mobility; normal mobility; and low or no mobility. In another embodiment, the method further comprises receiving a subscription request from the NADSF, where optionally the subscription request is associated with the UE.

It will be further understood that the above description supports network functions and nodes that carry out these methods. Additionally it will be understood that the embodiments of the methods may be based directed from the method or may be combined with each other.

Although the present invention has been described with reference to specific features and embodiments thereof, it is evident that various modifications and combinations can be made thereto without departing from the invention. The specification and drawings are, accordingly, to be regarded simply as an illustration of the disclosure as defined by the appended claims, and are contemplated to cover any and all modifications, variations, combinations or equivalents that fall within the scope of the present invention.

1. A method of cell selection performed by a user equipment (UE) comprising:
obtaining physical cell identifier (PCI) information associated with an access node in accordance with a signal received from the access node; and
transmitting a registration request to the access node using system information associated with the access node, the system information selected from a stored map in accordance with location information associated with the UE and the obtained PCI.

2. The method of claim 1 wherein the location information comprises area identification information from a master information block received from the access node.

3. The method of claim 2 wherein the area identification information defines a region comprising access nodes, with each access node within the region having a unique physical cell identifier (PCI).

4. The method of claim 2 wherein the stored map further includes system information and a system information version number for each access node and the master information block for each access node includes a system version number; the method further comprising:
retrieving system information version number from the map;
comparing the retrieved system information version number with the system version number contained in the received master information block; and
using the system information from the map for each access node in which the map system information version number matches the master information block system information version number.

5. The method of claim 4 further comprising, for each access node for which the retrieved system information version number does not match the system version number contained in the received master information block for that access node:
decoding system information block information received from that access node.

6. The method of claim 1 further comprising locally determining the location information.

7. The method of claim 1 further comprising requesting a map update responsive to a triggering criteria.

8. The method of claim 7 wherein the triggering criteria comprises receiving a better quality signal from an access node not identified in the stored map.

9. The method of claim 1 wherein the stored map further includes policy information, the method further comprising:
determining criteria is satisfied according to the policy information included in the map; and
selecting an access node responsive to the determining.

10. The method of claim 1 wherein obtaining PCI information comprises determining the PCI in accordance with synchronization signals transmitted by the Access Node.

11. A user equipment (UE) comprising:
a processor; and
machine readable memory storing executable instructions which when executed by the processor configure the UE to:
obtain physical cell identifier (PCI) information associated with an access node in accordance with a signal received from the access node; and
transmit a registration request to the access node using system information associated with the access node, the system information selected from a stored map in accordance with location information associated with the UE and the obtained PCI.

12. The UE of claim 11 wherein the executable instructions further configure the UE to receive a master information block, containing area identification information, from the access node, and wherein the location information is determined in accordance with the area identification information.

13. The UE of claim 12 wherein the area identification information defines a region comprising access nodes, in which each access node within the region has a unique physical cell identifier.

14. The UE of claim 11 wherein the executable instructions further configure the UE to locally determine the location information.

15. The UE of claim 11 wherein the executable instruction further configure the UE to determine the PCI in accordance with synchronization signals transmitted by the Access Node.

16. A method performed by an access node comprising:
transmitting a master information block including area identification (area ID) information defining a region comprising access nodes, each access node within the region having a unique physical cell identifier (PCI).

17. The method of claim 16 wherein the master information block includes a system version number for each access node within the topological region.

18. The method of claim 16 further comprising:
receiving a map update from a network discovery function; and
transmitting the map update to a user equipment (UE).

19. The method of claim 16 further comprising:
receiving a map update from a network discovery function;
paging a user equipment (UE) to become active; and
transmitting the map update to the UE.

20. An access node (AN) comprising:
a processor; and
machine readable memory storing executable instructions which when executed by the processor cause the AN to transmit a master information block including area identification (area ID) information defining a region comprising access nodes, each access node within the region having a unique physical cell identifier (PCI).

21. The AN of claim 20 wherein the master information block includes a system version number for each access node within the topological region.
